(19) United States
(12) Patent Application Publication
(10) Pub. No.: US 2003/0233631 A1
(43) Pub. Date: Dec. 18, 2003

(54) Web services development method

(76) Inventors: Ambrose Curry, Dublin (IE); Stephen Brogan, Dublin (IE); Anthony Carville, Dublin (IE); Clive A. Jordan, Dublin (IE)

Correspondence Address: BROWN, RUDNICK, BERLACK & ISRAELS, LLP., BOX IP, 18TH FLOOR, ONE FINANCIAL CENTER, BOSTON, MA, 02111, US

(21) Appl. No.: 10/171,173

(22) Filed: Jun. 13, 2002

(51) Int. Cl. G06F 9/44

(52) U.S. Cl. 717/100; 717/104; 717/108; 717/115

(57) ABSTRACT

A method for rapid design, development, deployment and support of web applications based on web services with minimum customized programming, maximized reuse of software components and compliance with standard development frameworks. The method of the invention systematically addresses the problems that are consistently encountered by web application developers by providing a generic platform that solves these problems. The invention enables developers to deliver web functionality without requiring them to understand the many technicalities of developing functionality for a distributed internet based architecture, and uses best practices to produce encapsulated, tested, quality oriented, applications based on web services.

### FIELD OF THE INVENTION

The present invention relates to web services and more particularly to a development method for building web service applications.

### BACKGROUND OF THE INVENTION

The increasing popularity of network computing and the shift away from the use of standalone computer applications have significantly changed the means by which computer software is developed and distributed. Software developers face a new set of challenges and require new tools to create applications and manage dataflow across a variety of distributed systems.

Increasingly, the software or software components that are used by individuals are stored and run on remote servers. In order for server side software to be widely accepted it must be compatible with various communication standards, database formats, and hardware configurations. Application servers, sometimes called middleware, also provide an infrastructure that allows users to communicate and connect into legacy system databases. Most application servers, for example, are compatible with Oracle, Sybase and Microsoft database formats. Application servers also provide services for common internet needs such as storefront engines which provide personalization engines and product catalogs.

The advent of web services has introduced a new set of challenges for software developers. A web service is a single piece of software which, when activated, performs a specific task and achieves a specific result. For example, activating a web service called “get me all the sales opportunities currently active within our company” will return, presuming the user is authorized to view this information, all relevant sales opportunities. Technical issues including the location of the stored information and method of retrieving it are all pre-programmed into the web service. A web service typically performs all of the underlying work and provides results in a format that is tailored to the individual user's needs.

From a technical perspective, web services provide programmable access to functionality that can be used independently of its implementation via a self-describing interface based upon internet standards. Web services can also be dynamically accessed in a public repository on the world wide web such as the Universal Description, Discovery and Integration (UDDI) library and included in any web application.

Web services combine a diverse set of software components operating on distributed systems to deliver custom functionality. Significant compatibility issues must be addressed during development of web services in order for interaction to take place and data to flow properly between the components of a web service and between various different web services.

Developers of web service applications use various software development tools such as Microsoft Visual Basic, Microsoft Visual C++, and various Java tools to develop web services. Scripting tools such as Active X Server Pages by Microsoft (ASP) and Java Server Pages (JSP) are used to build applications that process server side functionality and deliver it as HTML.

Customers of web service applications include various e-commerce businesses. Examples of typical web applications include classic storefront functionality such as configuring products/variations etc, special office functions, personalization, standard database functionality, marketing campaign management, preferred customer lists etc. In another example, a web service application facilitates the interactions of a purchasing community for a particular industry. Such diverse needs of web applications customers are difficult to fulfill using development tools that include pre-packaged application components.

Users of many off-the-shelf development tools for developing web services, for example Intershop by Intershop of Germany, hoped to reduce development costs by using mostly prepackaged components that require very little customization. However, typical projects became more complex over the development life cycle so that significant customization by developers became necessary, resulting in a relatively small percentage of a final application being provided by the off the shelf development tool.

Typically, the software that is used to customize Intershop is Microsoft ASP which provides the interface layer into the Intershop product. The customization of applications under development is a monumental task for developers. Many of the same programming problems arose repeatedly. Although most applications share certain standard features, it is difficult to extract functionality from custom projects for sharing in other projects because much of such functionality is application specific. Such custom applications are also difficult to upgrade and support.

Several areas of development have been found to cause difficulty in almost every web application development project. One area that causes substantial difficulty is web technology such as state management and session management. State management refers to managing information as a user moves between various pages within an application. Session management refers to managing information between uses of an application, i.e., between user interaction sessions with the same page(s).

In the client server environment, a front end such as a Visual Basic front end application typically links to a database. The application act as a homogeneous unit that maintains a connection between the front end and the database. Accordingly, state and session management is not a significant problem for client/server application development. However, state/session management presents a significant challenge in a web service environment because every web service page is treated as a separate application that is disconnected from the server. If a web service application involves many different pages, each page may require an indication that the user had visited particular previous pages and may require a status of the interactions that the user engaged in at the previous pages.

Another significant problem consistently confronted by web service developers is user management including management of passwords, profiles, roles and privileges. Web service developers confront the difficult task of programming the user management functionality each time they develop a new application. The configuration of user roles and privileges in web service environments is typically complex because the user configurations must be properly integrated into each page.

Client-side environment management is another problem that is consistently encountered by web services developers. Users typically interact with web service applications by browsing the application using a particular version of a web browser such as Netscape Navigator or Internet Explorer. Each browser and each version of a particular browser typically offers different levels of functionality. Web service applications must be able to integrate with the different levels of browsers that are available so that any user can gain access to the application. Web application developers must be able to categorize the functionality that is available for each particular browser version, sense the browser version that calls the application and dynamically adapt to provide the richest set of functionality taking advantage of the capabilities that are available for the particular browser.

The task of programming client-side sensing functionality for each application is very difficult. Programming such functionality separately for each web service development project is cost prohibitive. To avoid the expense of adapting to each available browser function, most web service applications are not dynamically adapted to each browser. Rather, web services are typically designed for compatibility with a representative set of functions that are common to many browsers. This common method of web application development can not take advantage of the benefits that may be available on some browsers that are not part of the representative set. Ultimately, the richness of applications suffer by the use of a common-denominator set of browser functions.

Still further development problems that are consistently encountered by web service developers involve scalability issues including layer separability. Many of these problems are common to client-server environments and web service environments. Most software architectures include multiple tiers or layers. For example, the classical architecture is a “3 tier” (commonly called “n tier”) development architecture. A presentation layer is typically provided to present the information to the user. A business logic layer is typically provided to perform the actual information processing. And a data layer is typically provided to manage the data base access to stored data. Layer separability is desirable because it facilitates adaptation of software to different environments or interface requirements by simply changing isolated code segments.

When designing custom applications, for example, using ASP, developers typically integrate all of the n tier layers onto the same page, i.e., by mixing the presentation layer code with the business layer code and the data layer code. Such mixing of code causes extreme inflexibility. For example, it is extremely inefficient to change the data layer from a Microsoft database environment (i.e. MS SQL Server, MS Access, MSDE.) to an Oracle database environment because the code required to access an Oracle database is completely different from the code required to access a Microsoft database, and that code is embedded with code relating to other aspects of functionality.

Developers are often compelled to inefficiently embed code for facilitating several database environments onto a single page. Implementation of layer separability in custom applications is time consuming and costly. The increasing demands for rapid code development causes optimal layer separability to be neglected thereby resulting in the development of web service applications with reduced flexibility and scalability.

Another challenge that is consistently faced by web services developers is the requirement for code adaptability to different interaction devices. Well developed web service applications will be required to adapt to various interaction devices such as cellular phones, handheld computers and various wireless devices. It is very difficult to deliver the same functionality to such different devices. Custom applications that have been traditionally developed are difficult or impossible to adapt for use by these different devices.

Web service developers also consistently encounter complex debugging problems. Typically, in n tier architectures, ASP pages pull information from various sources, e.g. data from various database locations and business logic from other locations/applications. The locations of performance bottlenecks are difficult to determine because web environments by their nature are distributed computer environments. The traditional method of debugging in a web environment consists of much guesswork and or error diagnostics.

### SUMMARY OF THE INVENTION

The method according to the present invention enables rapid development of web services with minimum customized programming, maximized reuse of components and compliance with standard development frameworks. The method of the invention systematically addresses the problems that are consistently encountered by web service developers by providing a generic platform that solves these problems. The invention enables developers to deliver web functionality without requiring them to understand the many technicalities of network architectures, and uses best practices to produce encapsulated, tested, quality oriented, web services.

Business logic development steps efficiently collect and refine the various business requirements of a customer into a set of standard specification documents. Web service mapping steps then organize the business requirements into a set of prioritized web services. Interface templates are reused or created anew according to interface analysis and prioritization steps. Interface templates are also reviewed for compliance with a standard framework architecture. The standard framework includes a Function Implementation System which automates the creation of web service business functions. Interface components developed according to the present invention are systematically tested for usability according to a set of optimal usability testing steps.

Architectural analysis steps are performed to review the compatibility of code templates with the various environments in which the code will be implemented and to ensure that the design goals are met and that maximum reusability of code is being enforced. Entity extraction steps are performed to identify and extract reusable code segments from existing entities. Database design and creation steps are performed according to best practice database design steps.

Classes and components are designed according to a best practices business object framework. Web service applications are created by integrating the classes and components according to the business object framework. The function implementation system which uses a standard application template and an application generator to automatically create business objects is continuously enhanced by the addition of new business objects during the application creation steps.

A web services master library is populated and accessed according to the various steps of the present invention. Rework steps identify code that is robustly reusable for addition to the web services master library.

A rapid application development environment automates the creation of a presentation framework for web applications by combining existing templates, creating new templates, and configuring workspaces according to the standard framework. The rapid application development environment also automates deployment of the finished web application.

The methodology according to the invention advantageously reduces time to value for web service customers and provides quality proven web services having minimum debugging requirements. The standardized approach to development of web services according to the present invention benefits web service developers by requiring fewer people to support the applications and requiring a reduced skill set to develop applications with minimum support requirements.

The methodology according to the invention solves many of the recurring problems of web service development practices of the prior art by automating creation of state/session management functions, automating creation of user management functions, standardizing client-side environment management, automating layer separability, standardizing code adaptability to different devices, and minimizing debugging effort and time.

### BRIEF DESCRIPTION OF THE DRAWINGS

The foregoing and other features and advantages of the present invention will be more fully understood from the following detailed description of the illustrative embodiments, taken in conjunction with the accompanying drawing in which:

FIG. 1 is a flow chart illustrating the steps of a rapid web services development method according to an illustrative embodiment of the present invention;

FIG. 2 is a flow chart illustrating the business logic development steps according to an illustrative embodiment of the present invention;

FIG. 3 is an illustration of an exemplary mind-map;

FIGS. 4A-4C are illustrations of a set of exemplary mind-maps as used in an illustrative embodiment of the present invention;

FIG. 5 is an illustration of a business rules document as used according to an illustrative embodiment of the present invention;

FIGS. 6A and 6B comprise a swimlane diagram as used according to an illustrative embodiment of the present invention;

FIG. 7 is a flow chart illustrating the web service mapping steps according to an illustrative embodiment of the present invention;

FIG. 8 is a flow chart illustrating the interface template reuse analysis steps according to an illustrative embodiment of the present invention;

FIG. 9 is a flow chart illustrating the interface template creation steps according to an illustrative embodiment of the present invention;

FIG. 10 is a flow chart illustrating the framework review steps according to an illustrative embodiment of the present invention;

FIG. 11 is a flow chart illustrating the usability testing steps according to an illustrative embodiment of the present invention;

FIG. 12 is a flow chart illustrating the architectural analysis steps according to an illustrative embodiment of the present invention;

FIG. 13 is a flow chart illustrating the entity extraction steps according to an illustrative embodiment of the present invention;

FIG. 14 is a flow chart illustrating the database design and creation steps according to an illustrative embodiment of the present invention;

FIG. 15 is flow chart illustrating the class and component design steps according to an illustrative embodiment of the present invention;

FIG. 16 is a flow chart illustrating the application creation steps according to an illustrative embodiment of the present invention;

FIG. 17 is a flow chart illustrating the development and deployment application creation steps according to an illustrative embodiment of the present invention;

FIG. 18 is a flow chart illustrating the rework steps according to an illustrative embodiment of the present invention;

FIG. 19 is a diagrammatic view of a set of data structures according to an illustrative embodiment of the invention;

FIG. 20 is a context diagram according to an illustrative implementation of the present invention; and

FIGS. 21-23 are exemplary views of development tools used to access metadata according to an illustrative embodiment of the present invention.

### DETAILED DESCRIPTION

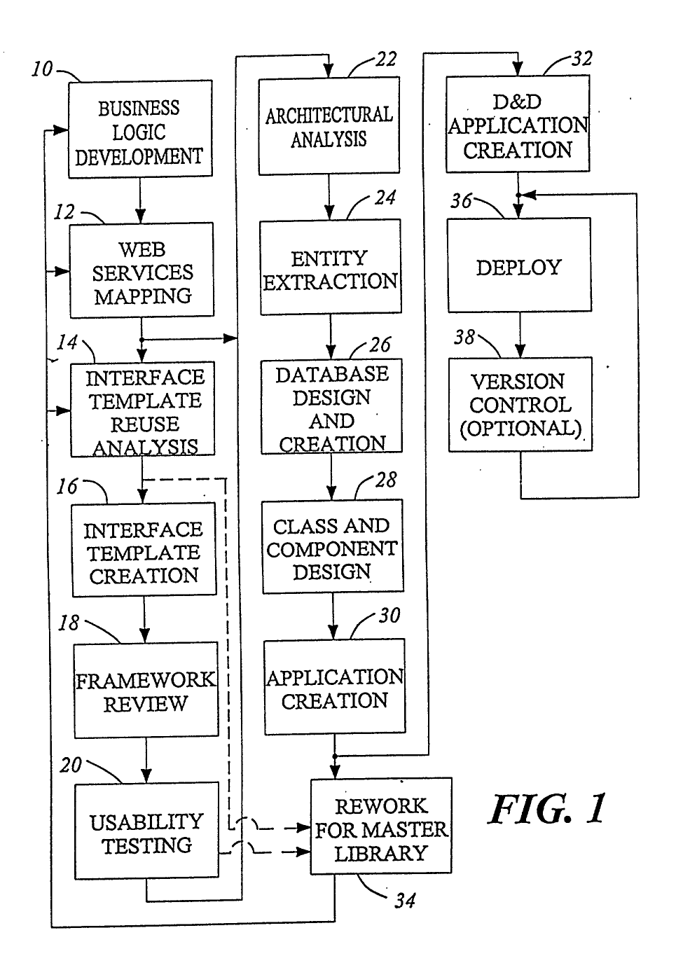

A rapid web services development method according to the present invention is described generally with reference to FIG. 1. A business logic development step 10 is performed at the beginning of a web services application development cycle to define the precise functions that are to be performed by the web service under development. During this step, the needs of the service end-user are evaluated to precisely define the required functionality of the web service. The output of a business logic development step 10 can be, for example, a set of documents such as tables, flowcharts and technical specifications.

Next, a web services mapping step 12 is performed to relate the business logic definition documents to a set of web services. Web services that are related to the business logic definition at this point are typically functional only, having no graphic interface. Logical grouping is performed to combine functions and identify suitable web service candidates to be developed or to be gathered from a repository of reusable web services. Once the web services that need to be developed are identified they are prioritized. Web services deemed to be above a priority threshold are passed along for further development. Development of web services that are below the threshold can be postponed or cancelled.

If the web services have an interface component, an interface template reuse analysis 14 is performed on the prioritized set of web services. An interface template master library is checked to see if any interface templates for the web services to be developed already exist. A list of interface templates that will be needed for the applications are categorized according to their availability. A list of template specifications is then generated and prioritized. The prioritized list of templates with their availability characterizations is then passed on for further processing.

Next, a prototyping step or interface template creation step 16 is performed to develop the presentation layer. Depending on the categorization of the template, either a new template may be developed, an existing template may be modified, or a reusable template may be incorporated. The result of the template creation step is a set of prototype interface pages or templates.

A framework review 18 can then be performed on the interface templates. The framework as referred to in the present invention is an overall architecture which provides a template for building enterprise web solutions. The framework includes a pre-built architecture that allows developers to rapidly create applications based on business components and web services. The framework architecture provides infrastructure for the simplified creation and customization of enterprise solutions. The template or infrastructure includes a library of business components for developers along with essential functional code that is required for generic applications. The framework template can be understood as a blueprint or generic application structure that enables fast generation of component based systems.

The framework structure reflects the essential make-up of a well built enterprise solution. The structure includes a number of layers or sub-architectures. Each layer addresses a specific area within a standard web application. The sub-architectures are independent of each other and can be used separately. The sub-architectures are linked using XML as a standard communication mechanism to provide an integrated, structured and extensible development environment.

The framework includes primarily three main sub-architectures. One of the sub-architecture is referred to as the Business Object Framework (BOF). The BOF is basically a template for creating components which provide the main processing logic within an application. Components available to the BOF include, for example, Visual Basic components which have been registered as a DLL using COM+ services.

Another of the primary framework sub-architectures is referred to as the Functional Implementation System (FIS). The FIS is basically an object factory for business objects within the framework, where a business object is defined as an implemented piece of business process or function. The FIS layer provides developers with a single interface to business objects thereby allowing them to call many different types of objects from within their application while using the same interface. These business objects may be BOF components or external business objects in the form of Web Services. The business objects are registered in the FIS where XML metadata is stored. This metadata describes the object's interface and implementation details.

A third primary framework sub-architecture is referred to as the Presentation Framework (PF). The PF layer manages the interface to and interactions with end users of the application. The PF creates a presentation sub-architecture which is device/browser agnostic.

During the framework review 18 of the interface templates, a developer reviews the prototype from a framework perspective and insures that the interface templates are achievable in a framework context. If it is ascertained that this is not the case, then the framework developer may suggest different ways of achieving the same end result, by suggesting changes in the visual interface template design.thereby ensuring that the interface specifications are framework compatible.

Upon completion of the framework review 18, a set of final interface specifications undergo a usability testing procedure 20. The interface templates are carefully tested for usability according to a set of usability test scripts. Feedback from usability test subjects is reviewed and any necessary changes to the interface prototypes are implemented. Modified prototypes are retested until user testing yields satisfactory results.

After the presentation layer development is complete, a general architectural review 22 is performed. During the general architectural review, design goals, technologies, security and code reuse is considered. An entity extraction step 24 is then performed to identify data entities for re-use and define any necessary new data entities.

Once the necessary new data entities are defined, a database design and creation step 26 is performed to develop any new data entities identified and defined in the entity extraction step 24. Database structures, security architectures, procedures and views are defined and reviewed.

Illustrative database structures according to the present invention are shown in FIG. 19. In this illustrative embodiment of the invention, there are three table database structures wherein one table is called Person_Details 192, another table is called Person_Role 194 and a third table is called Role 196.

The connecting lines between the tables also represent database structures called ‘Relationships’. For example the line 195 between the table ‘Person_Role’ 194 and the table ‘Role’ 196 signifies that there is a relationship between the field ‘RoleID’ 197, 197′ in each of the tables. In other words, for a row in the table ‘Person_Role’ 194 to be valid or allowed, the value of its field ‘RoleID’ 197 has to already exist in the table ‘Role’ 196. This is commonly known as a ‘Parent/Child’ or ‘1 to many’ relationship, and is a specific structure within the database.

The tag ‘PK’ 191, 191′ shows that a particular field is the ‘Primary Key’ field for that table, or in other words, that field can only be populated by unique values, thereby ensuring that no two records in the table can be exactly the same. For example, in the table ‘Role’, 196 the field ‘RoleID’ 197′ is the primary key. The tag ‘FK’ 193 means ‘Foreign Key’ and shows which field is the ‘Child’ side of a parent/child relationship. Where two fields in a single table have the ‘PK’ tag 191, 191′ associated with them, as in table ‘Person_Role’ 194, the combination of those fields forms the unique attribute for that table.

In the database design and creation step 26 (FIG. 1), the data structures and procedures are reviewed to ensure that they faithfully represent a description of the actual item or actions that they are designed to represent, and to make certain that essential mechanisms such as the primary keys (PK 191, 191′ in FIG. 19) in the illustrative embodiment are in place so that data integrity within the structures is ensured.

Once the database design is complete, a class and component design step 28 is performed. At this stage, new classes and components are designed within a framework architecture if it is determined that reusable classes and components are not already available. Any number of techniques and tool sets that are well known in the art of application development can be used to design the actual class and components. In an illustrative embodiment of the invention, the new and reused classes and components are structured to fit the Business Object Framework, discussed hereinbefore, within the broader framework architecture.

Once the new classes and components are designed and reusable classes and components are identified, an application creation step 30 is performed. During the application creation step 30, the application metadata is defined, then the application is created and reviewed. During the review process, the application can be analyzed to strive for optimal reuse of available components and to ensure that new classes and components are themselves designed for optimal reusability in the future.

If it is determined that the application design is not optimized for code reuse and reusability, a Rework step 34 can be performed to test reusability and rework or reject code that is not suitably reusable. Reworked classes and components can then be made available for repeating earlier steps beginning at the business logic development step 10, the web services mapping step 12 or the interface template reuse analysis step 14, depending on whether the reworked code pertains to business functions or interface functions.

If it is determined that the application design is sufficiently optimized for code reuse and re-usability, the designed application is completed in a development and deployment (hereinafter “D&D”) environment application creation step 32. At this stage of web service development, the developers use a D&D environment to rapidly form the various functional classes, components, and presentation templates into a deployable application.

In an illustrative embodiment of the invention, the Epiowave™ environment available from the applicant, Epionet Corporation of Dublin, Ireland, serves as the D&D environment in the D&D application creation step 32. After the D&D application creation step 32 is performed, the application is typically ready for deployment 36. In the illustrative embodiment, the D&D environment also acts as a deployment utility to enable rapid deployment of the completed web service. After deployment of the web service, a version control step 38 can then be performed to maintain the web service for continued compatibility with the business object framework architecture and continued implementation of the latest available reusable code segments.

Business Logic Development

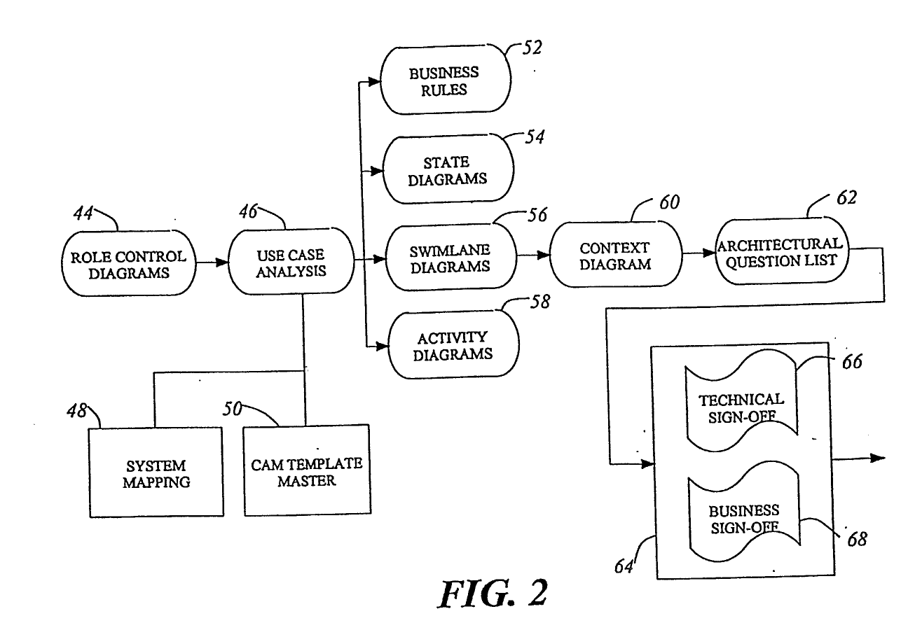

Referring now to FIG. 2, the steps which fall within the Business logic development step 10 will be considered in detail. During the business logic development step 10, a precise description of the customer's business requirements or the business logic requirements of the web services under development are compiled by performing an orderly sequence of steps. No consideration is given at this stage to platform issues or re-use of services or code.

The business logic development step 10 includes initial discussions with the customer, to fully understand and refine the business requirements and then precisely define the web service requirements and specifications.

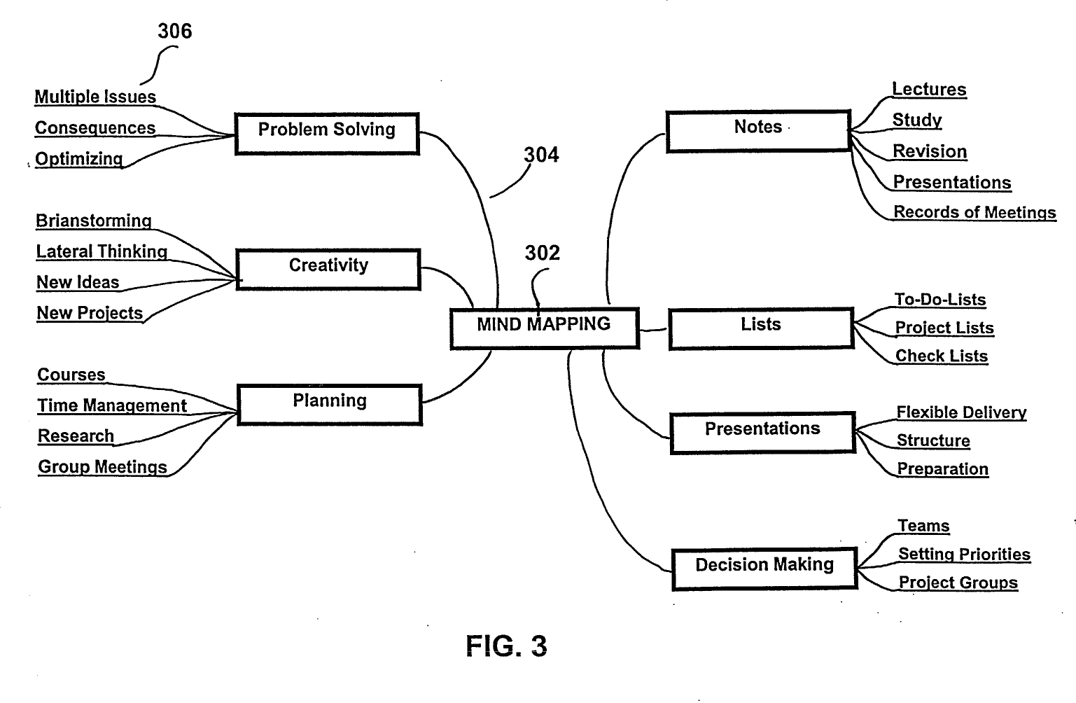

First, a set of Role Control Diagrams 44 is developed and a Use Case Analysis is performed 46. In an illustrative embodiment of the invention, a toolset called MindManager by MindJet LLC of Sausalito, Calif. is used to create mind-maps which assist in the steps of creating the Role Control Diagram 44 and performing the Use Case Analysis 46. Mind-maps are a well known brain storming device for organizing information. An exemplary mind-map is illustrated in FIG. 3. A subject is represented by a central image 302. Main themes of the subject radiate from the central image 302 as main branches 304. Minor themes 306 are linked to the major themes 304. All of the branches of a mind map are connected to form a nodal structure.

The business environment to which the web service under development will apply is analyzed from a number of perspectives. Referring again to FIG. 2, during the Role Control Diagram step 44, a set of roles is defined. For example, during development of a financial services application, the rolls of administrator, accountant, or business manager etc. could be defined. Note that these roles do not refer to a particular person, rather they are acting roles. Attached to each roll is a set of “I want to's” or functions. For example the accountant role may ‘want to see all the out going funds for a specific period’; a manager role may ‘want to see all the projects that are running behind schedule’.

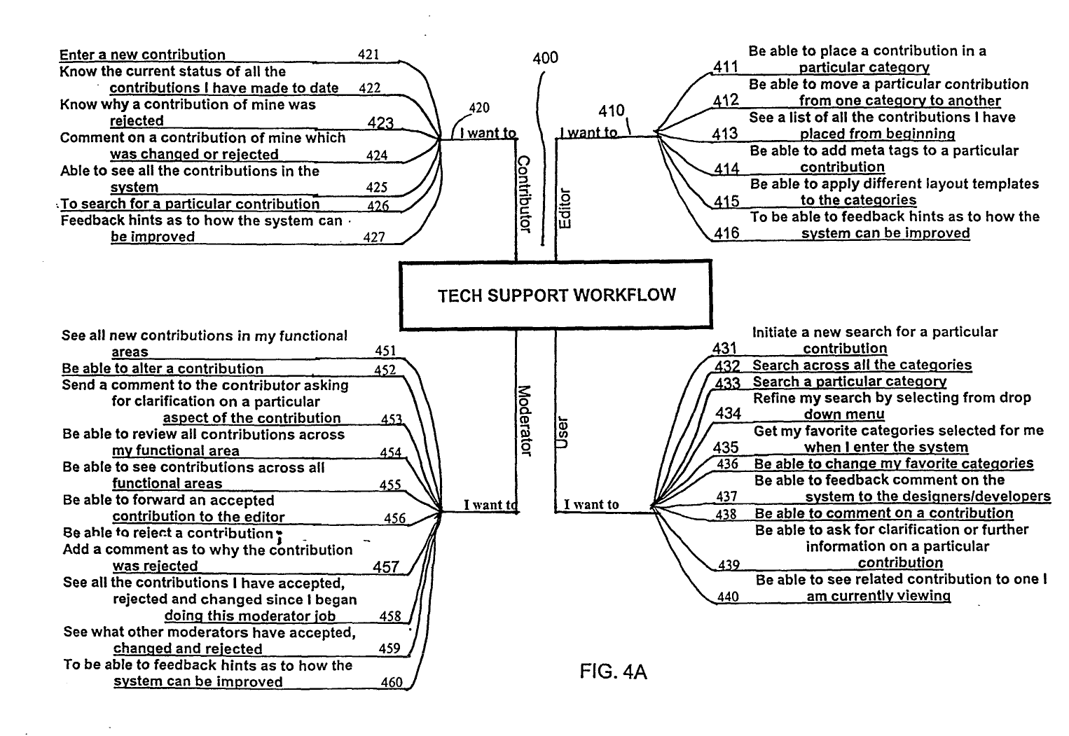

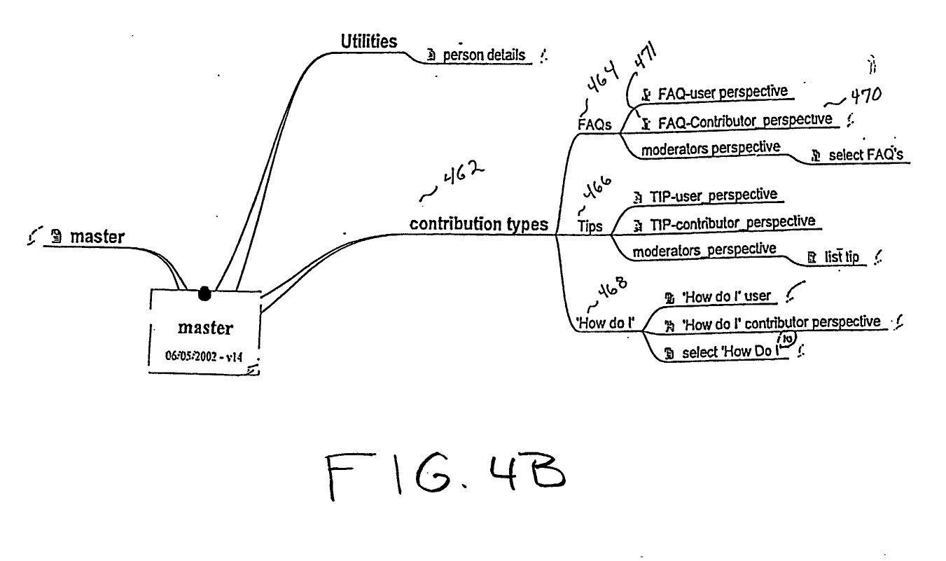

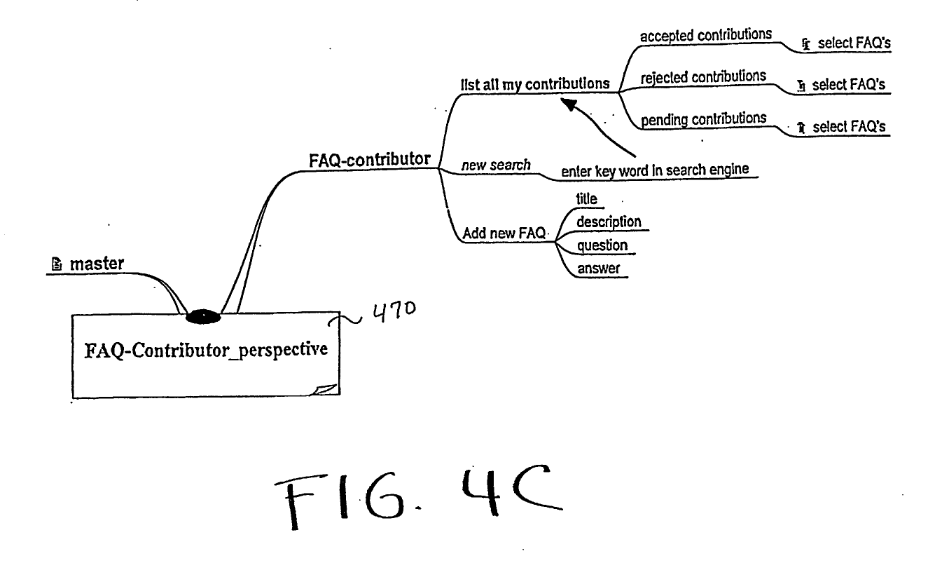

In another illustrative embodiment of the invention as shown in FIG. 4A, a mind-map 400 called Workflow RoleControl.mmp provides an example of how the roles and the scope of each role are captured in a single role control mind-map form. The roles in the illustrative embodiment as shown in FIG. 4A are Editor 410, Contributor 420, User 430 and Moderator 450. The scope for each role is defined by the set of ‘I want to’ statements 411-416, 421-427, 431-440, 451-460 as shown on the mind-map 400.

By defining each role and each function for each role, the precise scope of an application or business solution can be quickly specified. Referring again to FIG. 2, the development of Roll Control Diagrams 44 streamlines the definition of project scope as compared with more traditional methods of defining a project where comparatively unstructured narrative specifications are used.

Next, a Use Case Analysis step 46 is performed during which the functions attached to each role are broken down into a set of use cases. The use cases are descriptions of the tasks that define the particular functions, the parameters or information requirements of those functions and toolsets that might be required by those functions.

A given role may have some number of functions, each of the functions will have associated parameters and/or toolsets. In an exemplary embodiment of the invention, wherein a particular role is defined to be “customer,” the parameters could be, for example, customer name, customer address, date of birth etc. In another exemplary embodiment, during development of a travel agent web service, one of the roles is defined as a reservation agent. The reservation agent role has a list of actions that it must be able to perform, i.e., the list of functions that the reservation agent wants to get at through their portal interface. For example, one action a reservation agent must be able to perform is to “list customers”.

The parameters or information space associated with the function “list customers” include a list of customers, the customer names, home addresses etc. The toolsets associated with the function “list customers” includes, for example, functions to add and delete customers. Toolsets associated with a use case or function define the actions that can be performed for that particular use case or function. Each of the function information spaces and toolsets is broken down to the highest granularity.

Another illustrative Use Case Analysis 46 is illustrated with reference to FIGS. 4B and 4C. Referring first to FIG. 4B, a use case called ‘contribution types’ is broken down into its constituent use cases: ‘FAQs’ 464, ‘Tips’ 466 and ‘How do I’ 468. Each of these are broken down further into their constituent use cases. Using the Mindmanager software described hereinbefore, hyperlinks are provided to develop even more granular use cases. For example, the use case called ‘FAQ-user perspective’ 470 can be accessed in more detail by clicking the associated hyperlink 471. Referring now to FIG. 4C, after clicking the hyperlink the developer is presented with the more detailed set of use cases associated with the the ‘FAQ user perspective’ 470.

Each of the use cases is defined by breaking it down to a sufficient level of granularity. Completion of the use case analysis 46 results in a detailed picture of the interrelationships in the information environment of the web service under development.

Once a complete set of documents and/or diagrams is developed according to the business logic development step 10, the use case analysis 46 is complete. According to the illustrative embodiment of the invention, these documents include any of or any combination of business rules 52, state diagrams 54, swimlane diagrams 56, and/or activity diagrams 58.

The business rules 52 are typically a simple narrative description or list of particular functions, parameters and toolsets. A simple list of business rules may be useful for describing defining functions when, for example, no complex interactions or state dependencies exist among the functions that require more sophisticated document formats. Business rules include the policies, constraints and conditions to be satisfied that underlie business processes. They define the operational relationships or restrictions governing information and how it is processed within a system and in some situations within a larger organizational context.

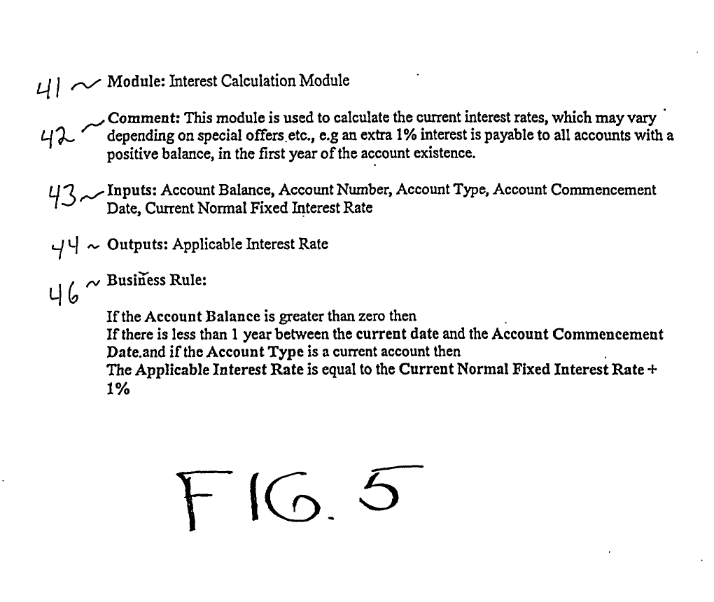

An exemplary business rules document is illustrated in FIG. 5. The business rules document in the example of FIG. 5 is structured to include five sections including Module: (title) 41, Comment 42, Inputs 43, Outputs 44 and the Business Rule 46. Any number of variations of business rules documents can be used according to the invention which may not necessarily include each of these sections. For example, persons skilled in the art should appreciate that the comment section 42 may be optional in some cases or that certain modules will not require an input 43 or output section 44.

State diagrams 54, swim lane diagrams 56 and activity diagrams 58 are document formats that are defined in the UML standard which is well known in the art. UML is framework/architecture that standardizes a set of tools and diagrams wherein each tool or diagram is targeted toward a specific section of the project specification process. UML provides a standard interface for integrating various other tools which can be designed by utilizing information in the UML diagrams. For example, data vendors can use the UML standard interface to automatically create data structures for use by any number of database tools.

Although the diagrams defined by the UML standards are used in the present invention, various diagrams used in the present invention may not necessarily comply strictly with the UML standard. For example, swim lane diagrams 56 used in accordance with an illustrative embodiment of the present invention include indications of data sources; whereas the UML standard swim lane diagrams do not necessarily include indications of the data sources.

State diagrams 54 depict conditions and responses of elements of a system. These diagrams depict states (typically denoted as rounded blocks) and state transitions (typically denoted as arrows between states) that represent the relationships between different states of a system. The state of system can be considered as a collection of state parameters whose values at any time contain all the information about the past that is necessary to account for the system's future behavior. See Herbert Hellerman, Digital Computer Systems Principles, McGraw-Hill, 1967, p. 237; John F. Wakerly, Digital Design Principles and Practices, Prentice Hall, 1990.

State diagrams are used in analyzing and designing systems where interdependent state transitions occur. Many processes require certain conditions to be met before an action in the process can be taken. In a business process, for example, an action “submit form” will depend on the completion of a previous action “create form” or “edit form”. State Diagrams 54 are most useful in cases where system responses are state dependent, and especially wherein such state dependencies are complex.

Swim lane diagrams 56 are created in cases wherein process control is necessary, e.g., wherein sign offs must be obtained or benchmarks must be reached before proceeding to a next step. Various software products for example Visio by Microsoft Corporation and Rational Rose by Rational Corporation are known in the art and can be used to assist in creating swim lane diagrams. These products may also be used to create the other UML standard document types.

A swim lane diagram shows an interaction consisting of a set of roles, their relationships and any data that flows between them. This type of interaction diagram emphasizes the sequential?? ordering of data flow and is useful in systems requiring a process, for example, wherein one action must await a sign-off or occurrence of a previous action. The actual process for each step can be depicted in a swim-lane diagram as a set of normal data flow, for example, showing data sources and users. In an illustrative process according to the invention the swim-lane diagram is generated with reference to the role control diagram, wherein the roles and/or data sources are labeled in the swim-lane diagram by following a labeling convention of the role control diagram.

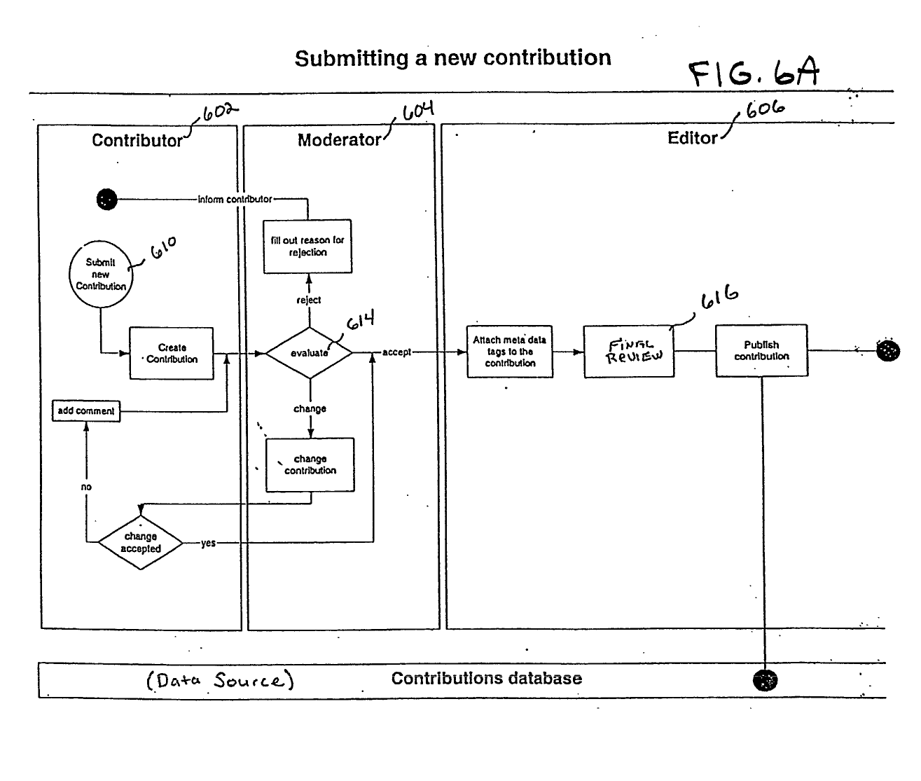

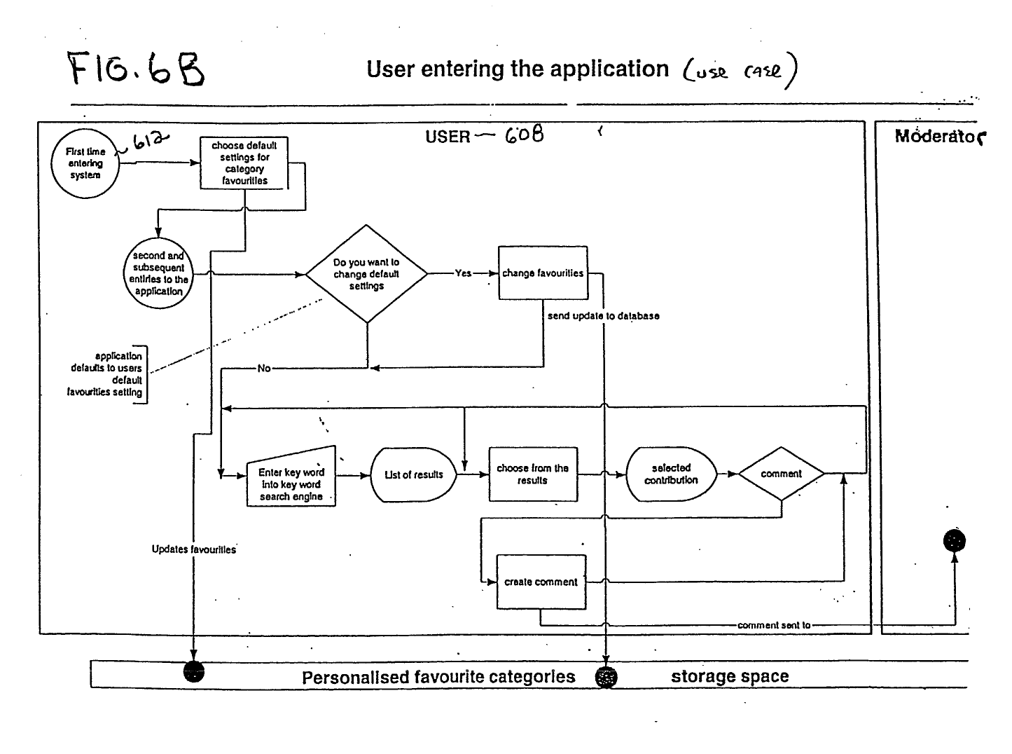

An illustrative use of a swim lane diagram can be better understood with reference to FIG. 6A and FIG. 6B. The illustrative swim lane diagram is used in the development of an exemplary knowledge management web service. The knowledge management web service is required to accept input contributions from experts to expand the knowledge base. Four roles 602, 604, 606, 608 that interact with the knowledge management system: user 608, contributor 602, moderator 604, and editor 608 are depicted in the swim lane diagram. Exemplary use cases that are illustrated in the swim lane diagram include “Submit New Contribution” 610 by contributor, and “First Time Entering System” 612 by the user. The information flow of the web service can easily be seen using the swim lane diagram. For example, when the contributor role 602 submits a new contribution which could be performed by pressing a submit contribution button on a user interface, the Submit New Contribution use case 610 carries out its functionality, i.e., receives knowledge files and/or parameters from the contributor and transfers them to the moderator. In one illustrative embodiment, the send contribution use case can be performed on proprietary hardware or, in another illustrative embodiment the send contribution event simply triggers an email describing the contribution to the moderator. The moderator role then requires the use case “Evaluate New Contribution” 614. The functionality associated with the Evaluate New Contribution use case 614 includes accepting modifications or comments from the moderator, and forwarding the modified or commented contributions to the editor role. The editor role requires a “Final Review” use case 616 having functionality that involves accepting, or rejecting of the contribution into the knowledge base system.

In the knowledge management example it can also be seen that a state diagram is useful to determine whether certain conditions have been met before carrying out dependent processes.

Activity diagrams 58 are another form of UML standard documents that can be used to describe a web service according to the present invention. Activity diagrams 58 provide focus and are preferred by some software developers. However, it should be apparent that all of the requirements of a web service can often be elicited from the customer of the development effort and described in complete detail without use of an activity diagram 58.

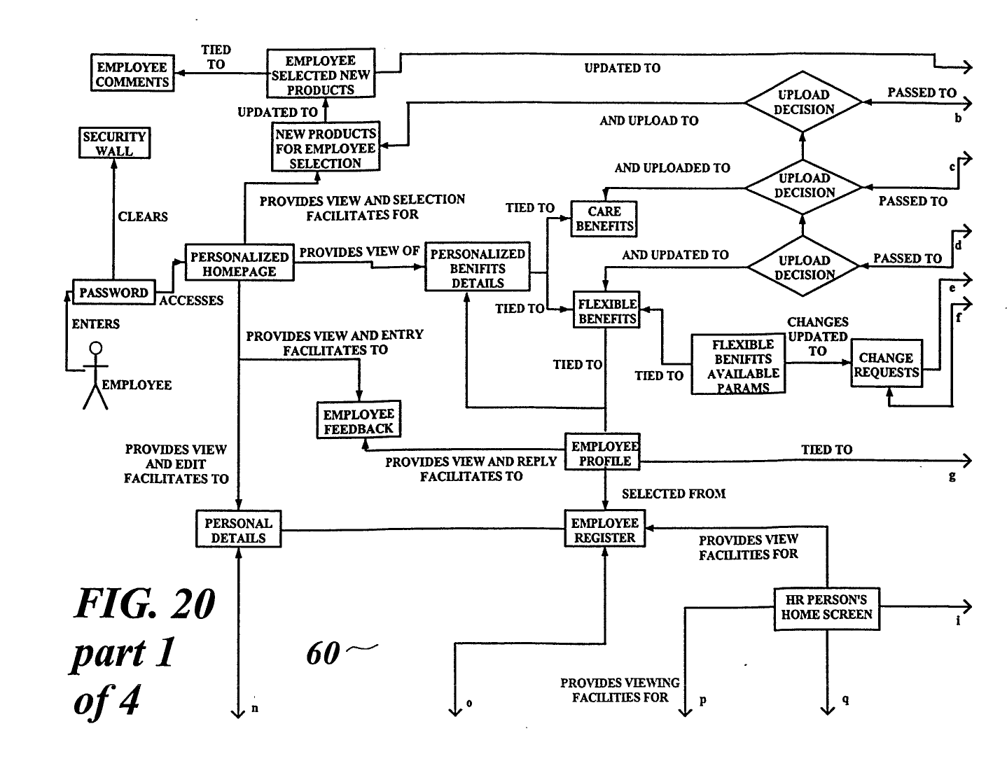

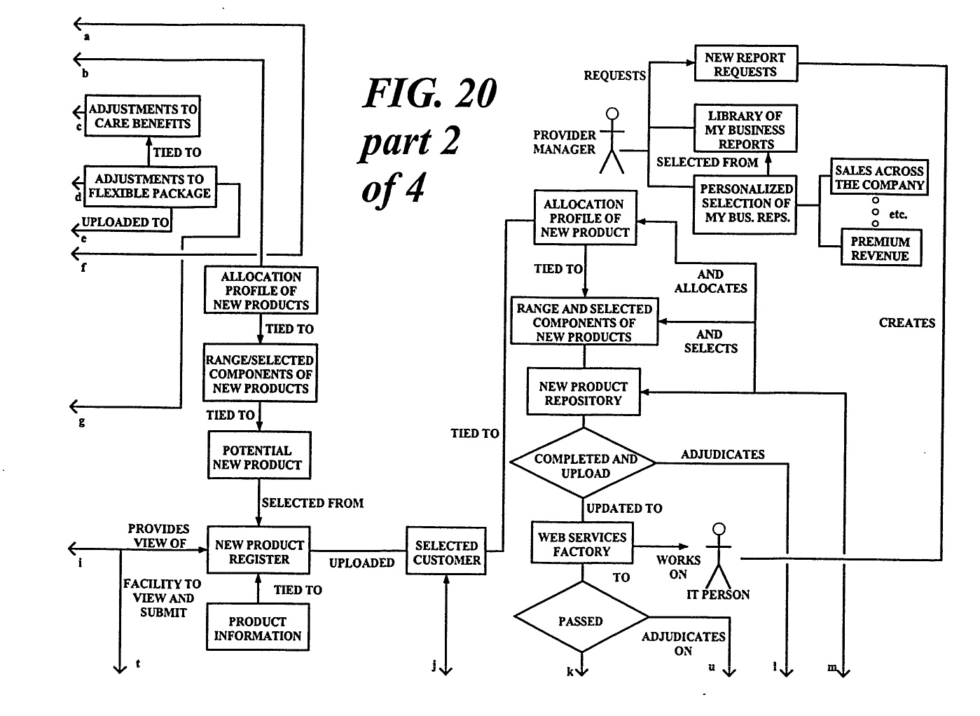

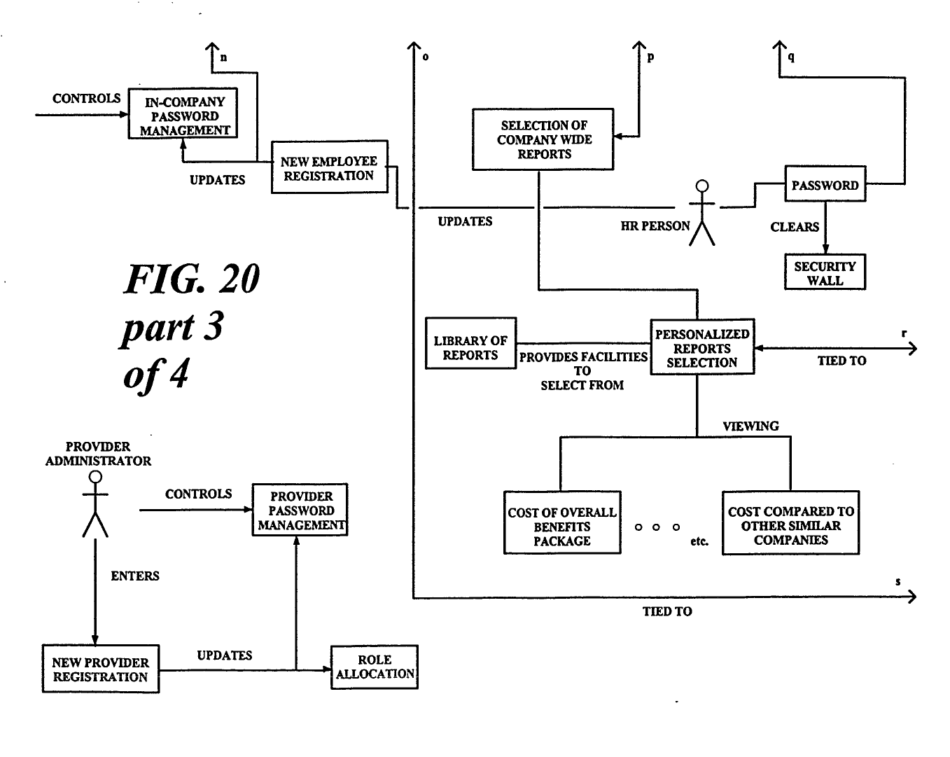

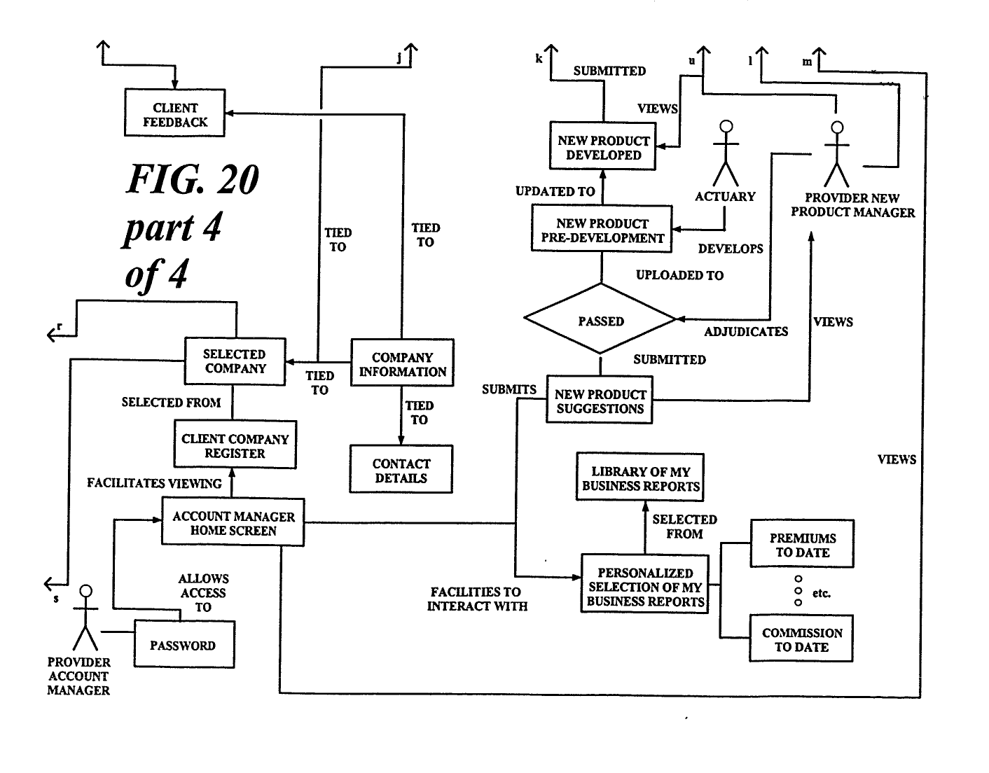

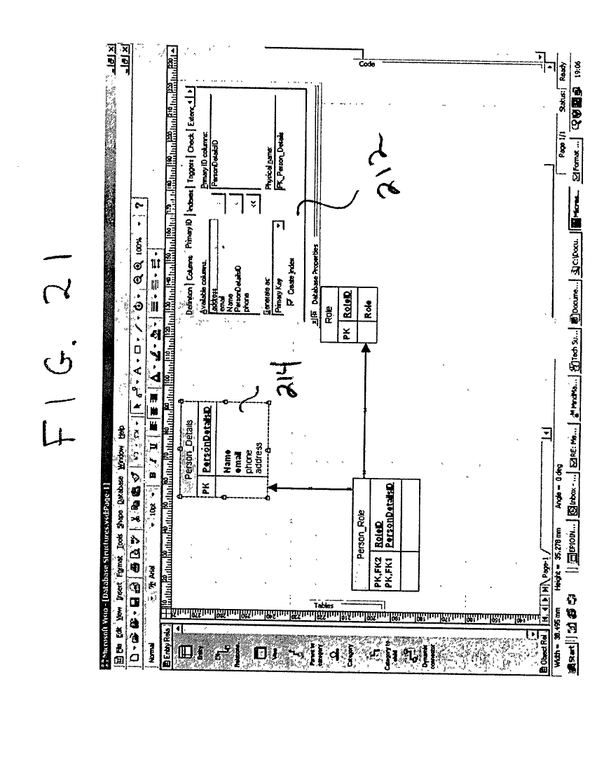

Once the various forms of project descriptions, including business rules 52, state diagrams 54, swim-lane diagrams 56 and activity diagrams 58 are complete, a context diagram 60 is prepared. FIG. 20 shows a simple example of a context diagram 60 as used in an illustrative example in the field of technical support workflow. The context diagram 60 provides a high level, low detail overview of the actors in a system and the activities that they undertake in order to achieve their task. The context diagram 60 also illustrates what interactions, if any, the actions require with other third party systems such as corporate HR systems for example. Thus, the context diagram 60 is used to represent the processes and different system interactions within an application.

Once the context diagram 60 is complete, all of the functional requirements of the web service under development have been fully defined. According to the method of the present invention, the architectural questions list 62 is then prepared to examine what toolsets and processes are needed in order to implement the required functionality. Architectural questions include, for example: On what platforms will the web service be required to run? Will the web service be operated in a net environment? Will the web service be used on particular hardware?; Can freeware be used to implement the web service? Will the web service be required to interface with databases (and what types)? Etc. An illustrative architectural questions list according to the present invention is embodied in a simple spreadsheet having a list of questions compiled after the functionality is defined addressing all non-functional issues.

Once the architectural questions list has been complete, all of the non-functional issues and the functional issues have been addressed. The end product of the business logic development step 10 (FIG. 1) is a complete description of the functional and non-functional requirements which typically takes the form of a set of documents including, for example, a set of mind maps; a physical list of architectural questions, a set of swim lane diagrams, a narrative description of business rules, and/or a state diagram. A sign off step 64 that may be divided into a technical sign off 66 and a business sign off step is also performed in the business logic development step of an illustrative embodiment of the method according to the present invention.

During the technical sign off 66 the documents are checked by applying an internal development focus to determine whether enough detail has been gathered from a technical perspective to implement the system requirements. The business sign off step is performed to ensure that the resulting documents accurately describe the product that the business customer requires, using an external customer focus.

In one embodiment of the present invention, the documents developed during the Business Logic Development step are color coded to indicate whether a particular functional requirement has previously been developed and is usable, requires modification, requires development anew or may be delayed until a later phase of a project delivery schedule.

Web Services Mapping

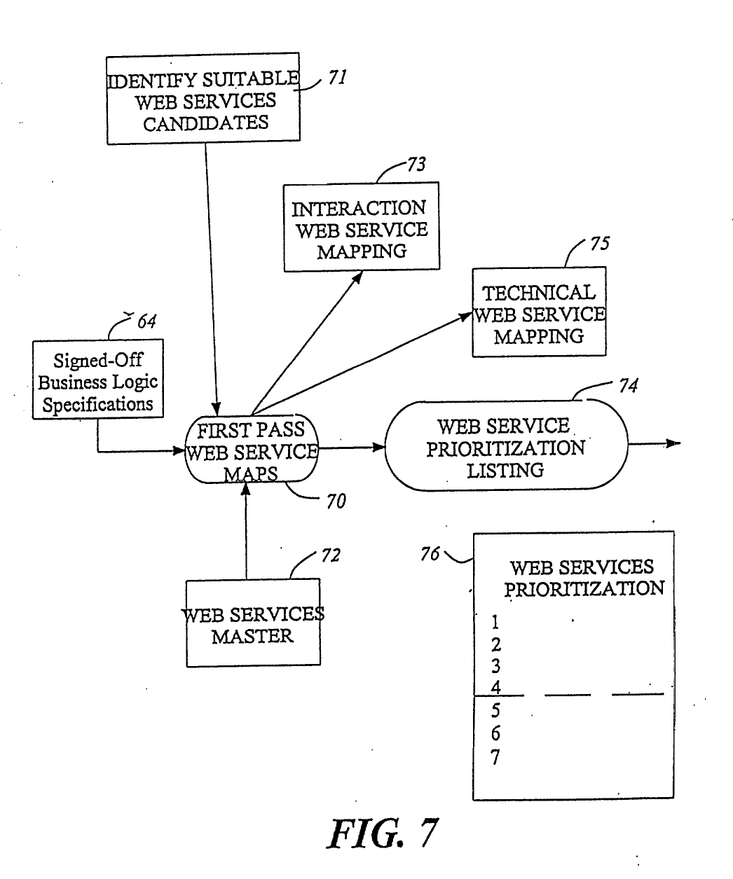

Referring again to FIG. 1, once the Business Logic Development step 10 is completed a Web Service Mapping step 12 is performed. During the Web Services Mapping step 12, the set of documents defining the functional and non-functional requirements of the web service under development are analyzed to determine how best to allocate development resources. The Web Service Mapping step is now be described in more detail with reference to FIG. 7.

Any number of functions may be required to implement a particular web service. In very large projects, for example, thousands of functions may be required. The step of creating First Pass Web Services Maps 70 operates on a list of the web services that have been identified in the Business Logic Development Step 10. During the step of creating First Pass Web Service Maps 70, a domain expert creates logical groupings from the list of web functions to identify suitable web services candidates. Three states of development are possible for each of the functions, i.e., the function has previously been developed and is readily accessible in a library; the function has not already been developed and must be developed from scratch; and a similar function exists which can be modified to develop the required function. The domain expert identifies which functions are at each of the development states. The domain expert may also identify certain functions that should be logically combined or some functions that do not logically fit the web service under development and should therefore be disregarded. In grouping the various combinations of functions, the domain expert typically adheres to a standard function naming convention.

For the functions that are fully developed, a technical web service mapping step 75 is performed. At this stage, the analysis of the web services that need to be created for the web service application under development has been completed. A list of the required web services has been formed. In order to minimize the amount of new development work required, the list of required web services is compared to a list of available web services in a web service library to determine if web services that perform the task of any of the required web services already exist. If such a web service already exists, then it is highlighted or otherwise noted on the list of required web services to indicate that the developer does not need to re-develop that web service within the context of the web service application under development. Since the business functions of a web service are typically non graphical, i.e., they have no user interface, an increasing number of relatively generic previously developed web services may be identified at this stage.

For those functions for which a similar function exists or which were partially developed, for example if a prototype only had been developed and the function required coding, an interaction web service mapping step is performed 73. During the interaction web service mapping step, a skilled practitioner recognizes whether a particular visual prototype is available from a visual prototype library, which fits the user interface requirement for representing a particular web service in the web services list for the project or web service application under development. In such cases where a visual prototype is available, the particular visual prototype or ‘Interaction Web service’ is used as the user interface and does not need to be re-developed. In some cases, partially developed web services are available from previous development efforts, for example, where many web services may have been already prototyped but not actually implemented in terms of the function details.

For those functions that must be developed from scratch, a prioritization list is required to determine which functions must be developed first. A “web service prioritization listing (business logic view)” step 74 is performed to determine prioritization. Prioritization is a critical step when determining the or most efficient path to follow in developing a particular web service. In an illustrative embodiment of the invention a particular algorithm to identify and create priority mapping. This algorithm involves calculating the importance of web services by generating a square matrix in which a column and a row is assigned to each web service. The importance of each web service can be compared to each other web service and an overall prioritization list can be generated such as by using a prioritization method that is described in detail in pp. 98-105 David Lewis, Information Overload, Penguin Books, 1999 which is incorporated herein by reference. It should be appreciated, however, that other algorithms can be used for prioritization of web services. A web services prioritization list 76 is created which includes an indication of a threshold level. Development of any functions that fall below the threshold level is deferred. The threshold level is typically determined according to availability development resources. In an illustrative embodiment, once the top ten functions have been identified development of only those functions proceeds and development of the remaining functions is deferred.

Interface Template Reuse Analysis

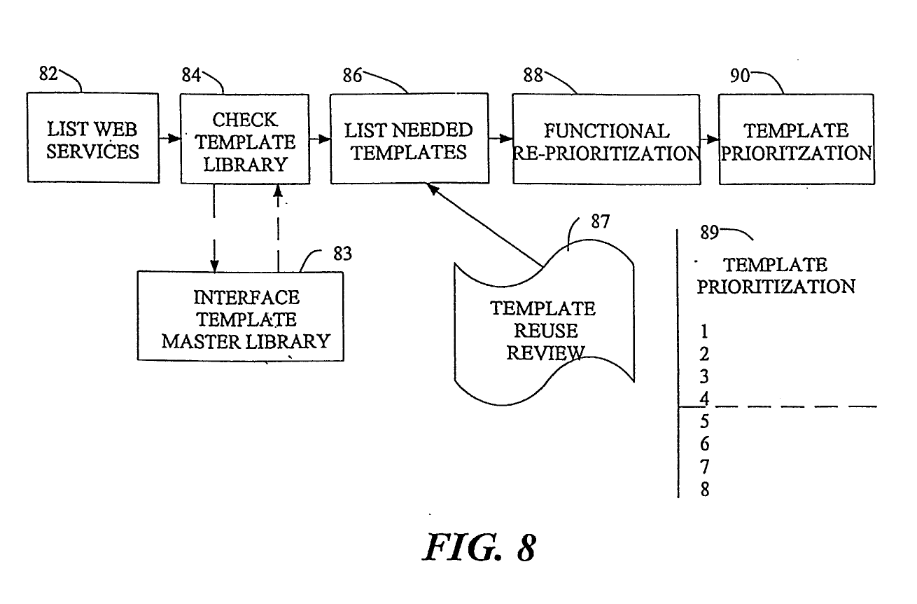

Referring again to FIG. 1, once the web services mapping step 12 is complete, either an interface template reuse analysis step 14 is performed or an architectural analysis step 22 is performed. The Interface Template Reuse Analysis step 14 is described in more detail with reference to FIG. 8.

Upon completion of the Web Services Mapping step the entire application has been characterized and the functional components of the application have been prioritized in the order of implementation to be coded and/or prototyped. A prototype can be defined generally as a visual representation of functionality that is not represented by any code. Prototypes are useful to demonstrate functions to a customer or end user before any functional code is written or actual functionality is developed. Usually prototypes are constructed using the HTML and XSL languages.

The first step in developing a template according to the present invention is a List Web Services step 82 in which a list of all web services potentially required for the application is created. Next, according to the present invention a Check Template Library step 84 is performed in which an Interface Template Master Library 83 is checked to determine which interface templates already exist in the library. The Interface Template Master Library 83 contains high quality standardized interface templates.

Some of the web services on the list of all web services will typically have an existing prototype but no existing code. Others will typically have already been implemented with code but will not have an associated prototype. According to an illustrative embodiment of the invention, a ‘List Needed Templates’ step 86 is performed which includes a Template Reuse Review step 87. A web service interface creation team determines which services have already been coded and checks a master library to see if the interface exists. In some cases wherein a new prototype is needed, part of that prototype may have already been developed in a previous project. It is at this stage that existing prototypes and portions of existing prototypes that may be combined or modified are identified.

In order to deliver rapid prototypes to a customer, according to the method of the invention, it is imperative to efficiently employ reusable prototypes or prototype components. Rapid application development generally requires rapid prototype development so that various quality assurance steps, such as demonstrating a function's interface for the customer, may be addressed at an early stage in the development cycle. Efficient rapid prototyping can best be achieved, for example, by developing and utilizing reusable screen real estate. In practicing the method of the invention, a prototype will typically be developed in an XSL format, however, the method may also be practiced by using prototypes in HTML format or mixing prototypes in HTML with XSL elements. In at least one embodiment of the present invention a standard framework is used wherein a user interface for a particular set of functions is automatically created.

Once the needed templates have been identified, a Functional Re-Prioritization step 88 is performed in which the business function (web service) prioritization list is reconsidered and evaluated in light of availability of reusable templates. In some applications, the priority level of business functions may be changed at this stage due to the costs of developing an interface prototype. Next, according to an illustrative embodiment of the invention, a Template Prioritization step 90 is performed. The Template Prioritization step 90 is similar to the Web Service Prioritization step 74 (FIG. 7) and prioritizes the list of templates to be developed in accordance with the priority with associated business functions, ability to use existing components and resources necessary to develop the templates. Any of various types of prioritization mechanisms may be used to prioritize the templates. For example, the same algorithm used to prioritize web services may be used in some cases to prioritize the templates.

A threshold level is determined according to available resources and development of templates having prototypes below the threshold is deferred. Once the Interface Template Reuse Analysis 14 (FIG. 1) is complete, the resulting template priority list provides the most efficient order of template development, along with a categorization of templates to indicate whether they must be developed from scratch, modified or reused.

Interface Template Creation

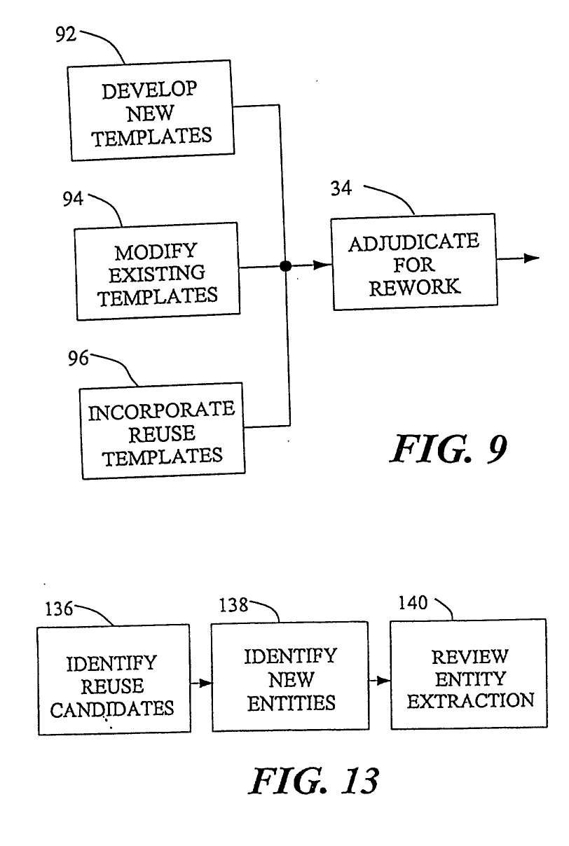

Referring again to FIG. 1, according to the method of the invention, once the Interface Template Reuse Analysis step 14 is complete an Interface Template Creation step 16 is performed. In some applications, however some of the web services or templates that are partially developed may require rework to comply with reusability standards or form. In these cases a Master Library Development step 34 is performed. The Interface Template Creation step 16 will now be described in more detail with reference to FIG. 9.

A ‘Develop New Template’ step 92 is performed to develop those templates that require development from scratch. A ‘Modify Existing Template’ step 94 is performed to develop those templates that require modification of an existing template where appropriate. An ‘Incorporate Reusable Template’ step 96 is performed to employ templates that have previously been developed.

Once a prototype has been developed, an optional ‘Master Library Development’ step 34 can be performed according to one embodiment of the invention wherein the prototype can be evaluated to determine whether it should be added to the Interface Template Master Library 83 or reworked and added to the Interface Template Master Library 83.

When all of the interface templates above the threshold on the template priority list have been developed according an illustrative embodiment of the invention, the resulting work product includes a set of screens that can be negotiated which have the look and feel of the application under development without actually performing the actual business functions. Any screen may be associated with one or more web services that perform the various business functions.

Framework Review

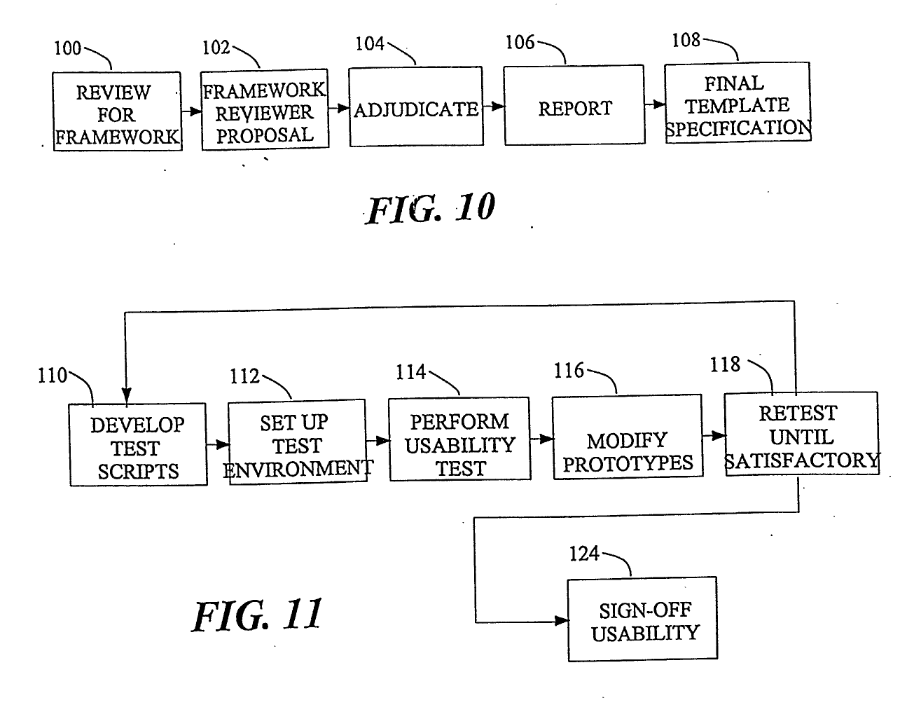

Referring again to FIG. 1, after completion of the Interface Template Creation step 16 a Framework Review step 18 is performed according to the invention, which is described in more detail with reference to FIG. 10. The Framework Review step 18 ensures that the Interface Templates that have been developed comply with an overall set of Framework requirements. The Framework requirements define a standardized method of creating applications or creating templates according to the invention. At this stage of development, a framework reviewer who has particular expertise with regard to the Framework architecture, can use the template to interpret or determine the type of information that is needed on the actual screen in order to handle the desired data representations. For example, the Framework reviewer can consider the requests in the template for formatting data or merging data from other applications to determine the type of information that is desired according to the prototype designers, and suggest Framework-compliant alternatives if the desired information does not comply with the Framework architecture.

Referring to FIG. 10, the Framework reviewer reviews the prototype from a framework perspective 100. It should be understood that the Framework reviewer may be the same person as the overall application developer or the prototype developer, who is required according to the invention to consider the prototypes at this stage of development from the Framework perspective.

In an illustrative embodiment of the invention, if the interface template creation step 16 (FIG. 1) results in a prototype that does not comply with the Framework architecture, the Framework reviewer can recommend changes to the prototype. For example if the prototype includes an unusual way of representing a certain application on the screen that does not correspond to a representation that has already been implemented as a template in the framework, the Framework reviewer may propose an existing mechanism that could handle representation of data required for this application that already exists. This alternative mechanism will typically be different from the mechanism that the prototype designers had suggested.

A proposal step 102 is then performed as part of the framework review in which the proposals of the Framework reviewer are provided as feedback to the prototype developer or prototype development team. Next, an adjudication step 104 of the framework review process is performed in which the prototype developer or prototype development team adjudicates the Framework reviewer's proposals. The adjudication step 104 is performed by evaluating whether to add the new mechanism to the templates that are available in the framework, or to use a mechanism that has been previously tested which will only take a short time to generate. This decision may be made for example as a result of cost/benefit analysis. The entire framework review phase ensures that development efforts are not wasted to further develop unnecessary novel prototype components but to allow development of novel prototype components in certain circumstances. For example, development of a novel prototype component may be allowed, if it satisfies or supports an explicit customer requirement.

In an illustrative embodiment, an experienced framework developer will first review the output from the prototype screens. The framework developer, here also the framework reviewer, will typically perform the review by thinking about the set of prototype templates he has been given, as compared to his knowledge of the available templates that fit the framework. He typically develops a proposal and reports the proposal to the members of a the team of adjudicators. The team of adjudicators typically comprises two or three people, possibly including the framework developer himself, the interface developer and a project leader. The adjudicators then typically meet to discuss the various advantages and disadvantages of the proposed prototype templates in view of the framework and decide whether to use the proposed prototypes or substitute another. The adjudication is typically repeated in an iterative evaluation step 106 until agreement has been reached among members of the adjudication team as to which prototypes will be used going forward. If a question is still outstanding that can not be resolved by the adjudicators, there may be a final arbiter, for example, the customer, who may dictate the use of a particular prototype. When the adjudication is complete a final template specification 108 is issued.

Usability Testing

Next, referring again to FIG. 1, a usability testing step 20 is performed which will be described in more detail with respect to FIG. 11. First, a scripting step 110 is performed during which usability test scripts are developed. As part of usability test preparation, the usability tests environment 112 is set up, then actual usability testing is performed 114. After a particular set of usability tests is performed, the test results or feedback from the test subjects is reviewed 116. Depending on the result of the usability test review, prototypes may be modified 118. After such modification the usability testing steps are typically repeated to test the modified prototypes. Additional modification and retesting 120 is performed until satisfactory usability test status has been achieved. Once all of the usability issues have been resolved, a usability sign off step 124 is performed to indicate satisfactory usability with regard to the prototype.

In an illustrative embodiment of the invention a small number of test subjects would be used to accomplish very rapid user testing. Typically groups of five users can be tested rapidly over periods from 20 to 30 minutes. The review step 116, modification step 118 and retesting steps 120 can be performed and repeated to rapidly work out any impediments to usability in the prototypes.

Although the method according to the present invention provides usability testing guidelines, any number of usability test methods may be employed within the scope of the present invention. For example, usability focus groups are sometimes used to evaluate various software components. Although such focus groups do not generally provide rapid usability test results, they may still be employed within the scope of the present invention. In an illustrative embodiment of the invention using rapid usability testing methods, the client or specifier of the application under development may participate or observe the evaluation of the usability tests.

The user test preparation typically includes preparing written guidelines for test subjects to follow, for example to complete five or six written tasks for a given component under test. When the test user has completed the assigned tasks, he submits a set of written results which are typically reviewed at a review meeting. In addition to the written results, the review meeting may typically evaluate video footage of the test subject while he was performing the assigned tasks and notes from observers who observed the test subject performing the assigned tasks. As a result of the review meeting, the interaction designers and developers typically meet to analyze and decide which changes, if any, will-be made to the components under test. Typically, changes are only made if specific significant reasons are agreed upon. An analysis document may then be prepared by the reviewer or review group.

Application Design and Creation

The steps of the Application Design and Creation phase according to the illustrative embodiment of the present invention, i.e., the Architectural Analysis step 22, Entity Extraction step 24, Database Design and Creation step 26, Class and Component Design step 28, Application Creation step and EpioRADD Application Creation step, comprise the actual creation of the functionality of an application under development.

Architectural Analysis

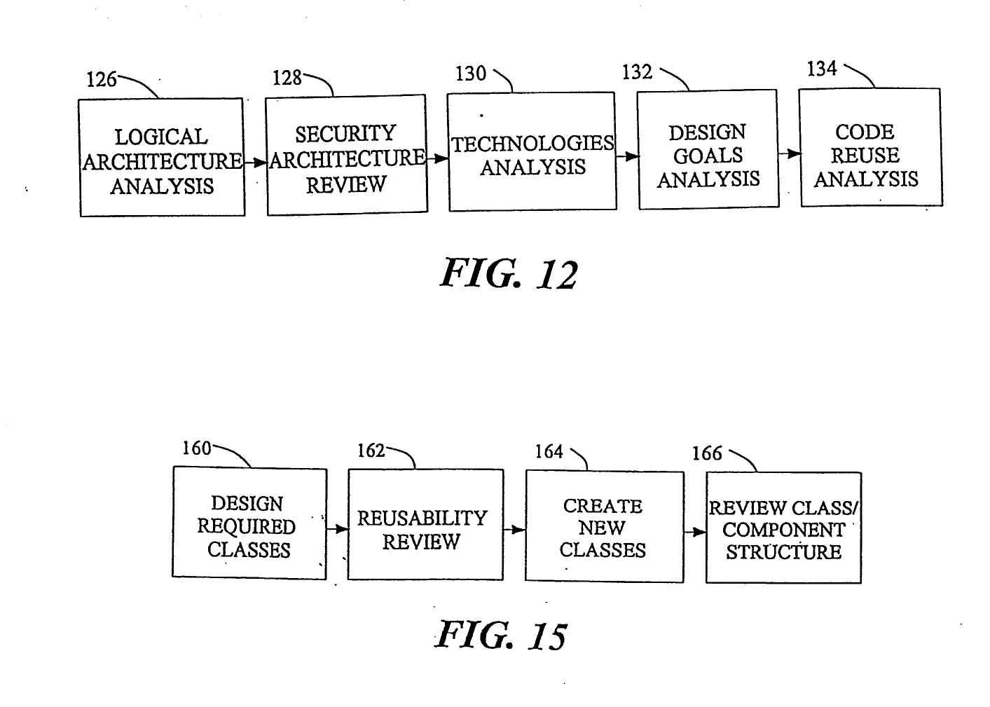

Next, referring again to FIG. 1, an Architectural Analysis step 22 is performed which will be described in greater detail with respect to FIG. 12. The Architectural Analysis step 22, according to an illustrative embodiment of the present invention is purely an intellectual exercise performed according to known best practices of the art and does not rely on any particular software tools. This step is performed to acquire a technology overview of the environment in which the application under development will be required to fit. For example, developers typically must determine which type of database environments will be accessed by the application under development and which type of programming environment it will be required to operate in.

In the illustrative embodiment according to FIG. 12, the Logical System Architecture Analysis 126 step is performed. The purpose of the Logical System Architecture Analysis step 126 is to reach an understanding of the complete logical structure required to deliver a properly functioning system. During the Logical System Architecture Analysis step 126, elements of the project solution such as data layer requirements, messaging infrastructures requirements, transaction handling mechanisms, methods of separating workflow logic from business logic and data layer logic etc. are identified.

Next, a Security Architecture Review 128 can be performed during which the developer or a person having specialized knowledge in application security, reviews the particular security requirements of the application under development. A technologies analysis 130 can be performed to determine technical details of the systems environment in which the application under development will be required to operate in order to define how the application will interact with the various operating environments. A design goals analysis 132 may be performed to determine whether a proposed architecture meets any specified or required design goals. A code re-use analysis 134 is also typically performed at this stage to ensure that the proposed architecture takes advantage of reusable code or may be able to contribute code for future reuse.

Entity Extraction

Next, referring to FIG. 1, an Entity Extraction step 24 is performed which will be described in greater detail with respect to FIG. 13. Typically the Entity Extraction step 24 is performed by a database specialist according to known best practices of the art. An identification of reuse candidates step 136 is performed to begin the creation of the data structures, i.e., the data files, the database tables, and the relationships between those data structures. Re-use candidate data structures are identified in any manner known in the art such as in a manner similar to the Interface Template Reuse Analysis 14 (FIG. 1). Similarly, an identification of new entities step 138 is performed by any means known in the art. Identification of reuse candidates 136 and identification of new entities 138 can be performed, for example using Rational Rose by Rational Software Corporation or any other of a number of standardized tools that are known in the art to help identify entities. These tools typically automatically create or aid in the creation of database constructions from combinations of reused entities and new entities.

The documentation and information collected according to the earlier steps of the present invention gives the developers a complete understanding of the business rules and business requirements of the application as well as a complete understanding of the entities that are necessary to deliver functionality according to those business rules and requirements. This allows the developers to more easily apply the tools used in the Application Design and Creation phase of development.

After the reuse candidates and new entities are identified, a review entity extraction step 140 is performed to confirm that the identified entities will actually suit the application under development. An optional report may be generated at this stage to document the entities that will be reused and those that will be developed from scratch.

Database Design and Creation

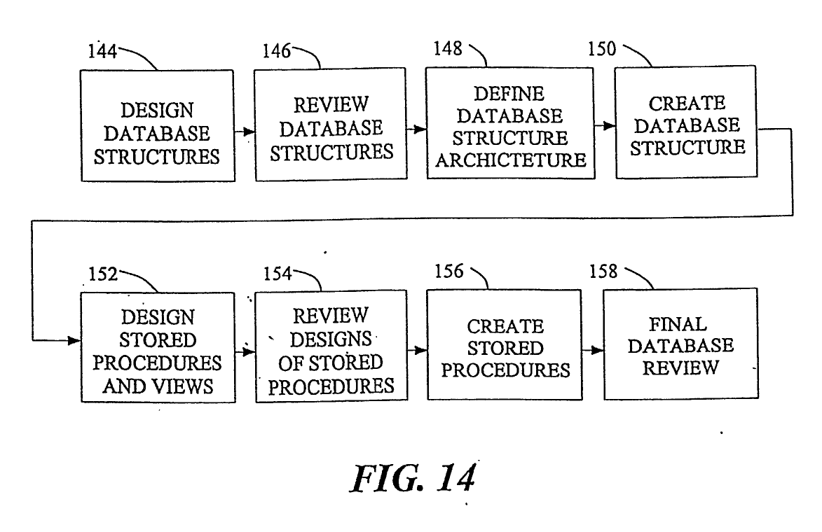

Next, according to an illustrative embodiment of the invention, with reference to FIG. 1, a Database Design and Creation step is performed. The Database Design and Creation step is described in more detail with respect to FIG. 14. The Database Design and Creation step is typically critical to the operation of the application under development and is therefore typically performed by experienced database developers.

First the database structures are designed 144 according to any means known in the art and in a manner chosen by the database designers. Then, the database structures are reviewed 146. The database structure review step 146 may be performed by the developer(s) who designed them or can be more formally reviewed by a review team which may comprise additional database design specialists. Next, the database security architecture is defined 148. After the database design has been reviewed and the security architecture defined, the database structure is created 150 in a manner consistent with the design and recommendations of the design reviewers. The creation of the database structure typically comprises creating the tables, indexes, relationships, user lists and user permissions. Various development tools are known in the art, for example Rationale Rose by Rationale Software Corporation, that automate some of the steps of the database creation. However, the database structure creation step 150 is typically very developer time-intensive as compared to other steps of the invention

After the database is designed 150, the stored procedures and views are designed 152 and reviewed 154 by database specialists in any of various manners known in the art. As with the review of the database design, the review of the stored procedures and view designs 154 may be performed by the developer(s) who designed them or can be more formally reviewed by a review team which may comprise additional database design specialists. After the stored procedures and view design reviews have been completed, the stored procedures and views are created in a manner consistent with the design and recommendations of the design reviewers.

Once the database has been created 150 and the stored procedures and views have been created 156, a final database review is performed.

Class and Component Design

Next, referring back to FIG. 1 according to an illustrative embodiment of the invention, a Class and Component Design step 28 is performed. The Class and Component Design step 28 is described in greater detail with reference to FIG. 15. This step is typically performed in strict compliance with the requirements of the Business Object Framework architecture. First, a Design Required Class step 160 is performed in which the functionalities, parameters and nomenclature of the required classes are defined. The required classes are defined according to the illustrative embodiment of the invention to comply with the Business Object Framework. At this point, the class nomenclature, parameters and function interfaces are defined.

A Reusability Review step 162 step is then performed to maximize reuse potential for the classes to be created. For example, the class designs are typically reviewed at this stage to ensure that the class designs including class names and parameter names are consistent throughout the various layers of the application under development within the Business Object Framework.

Next, a Create New Classes step 164 is performed during which the new classes, having been defined according to the Framework, are now created. In an illustrative embodiment of the invention, the actual classes are automatically generated by a Function Implementation System which acts as an object factory when provided with object designs according to the template provided by the Framework. Typically, the functions that can be automatically created by the framework include functions to list, add, edit, modify and delete data structures. Corresponding classes or components are also typically created in each of the various layers of the framework, to provide place holders with the appropriate naming convention and thereby facilitate data accessibility between layers.

Once the classes have been created, a Review Structure step 166 is typically performed to review class and component structure for the application. At this point, according to the illustrative embodiment, decision is made as to how the created classes and components will be combined within the application. Several architectural options are available. For example, the logical layers of the application may be each physically separated or may be combined into components that include multiple logical layers. These decisions are based on the specific hardware and the specific networking parameters, such as the number of users, number of servers. Experienced developers may be able to optimize the performance of the overall application by deciding to combine classes in a way that will best allocate the hardware resources when the various components of the application are running.

Application Creation

Referring again to FIG. 1, once the Class and Component Design step 28 is completed an Application Creation step 30 is performed. During the Application Creation step 30, a component based application is created that can be run outside of any D&D tool such as the Epiowave™ by Epionet Corporation. In an illustrative embodiment of the Application Creation step 30, a COM+component containing the functionality as required by the web service under development is created.

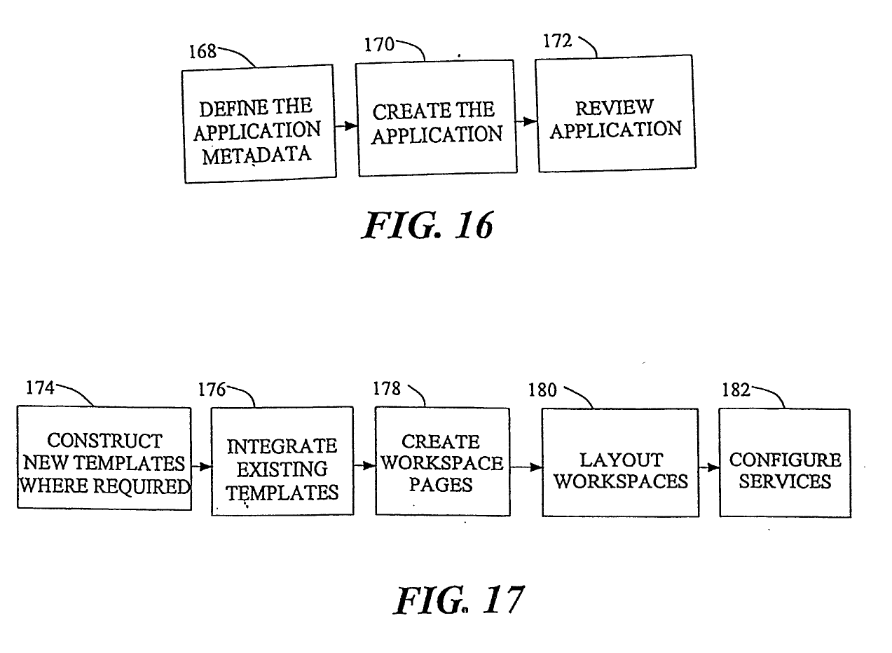

The Application Creation step 30 is described in more detail with respect to FIG. 16. First, a Metadata Definition step 168 is performed during which the application metadata is defined. Metadata is well known in the art as descriptive information about data and data structures. For example, referring again to the Role table 196 in FIG. 19, the two fields Role 198 and Role ID 197′ which are described using metadata including field type (i.e. string), field length (i.e. 50) etc. The metadata in the illustrative embodiment of the invention are properties that are used to configure each element within a database in order to instruct the database management system how to process information within that element. The metadata can be generated easily with the aid of metadata development tools such as Epiowave™.

During the Metadata Definition Step 168 of an illustrative embodiment of the invention, the application developer inputs to the Epiowave™ system as much information as the system needs to automatically construct the XML files, component files and Epiowave™ pages that will make up that Epiowave™ application being configured. This information includes information about the entity for which the application is being developed, such as the descriptive fields of the entity (name, email, telephone for example), their types (numeric, or alphanumeric for example), their length, and any information indicating how they should be labelled on the user interface. During the Metadata Definition Step 168, the application developer also decides if any validation processing is to be carried out on the entity, such as ensuring that the user inputs valid information in a telephone number field, for example.

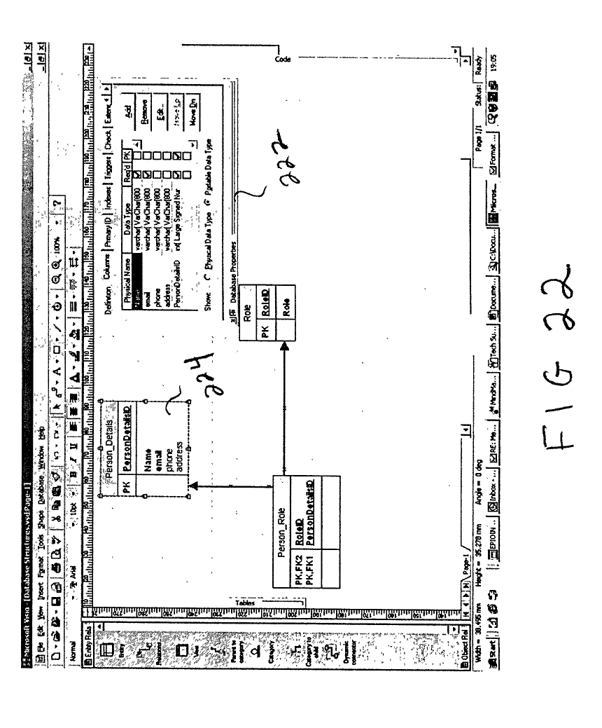

FIGS. 21-23 illustrate some of the tools that can be used by an application developer during the Metadata Definition Step 168 (FIG. 19) according to the present invention. The developer inputs the nomenclature and parameters for the various metadata into specific fields within the tool or development environment. The database properties window 212 in FIG. 21 shows and allows editing of the metadata for the table labled Personal_Details 214. In this example, the metadata includes the names of the fields, their data types, and their specified length. Here, the metadata also indicates whether or not a field is a primary key (PK), and whether a value is required for the field before the database can update new information into a record in the database.

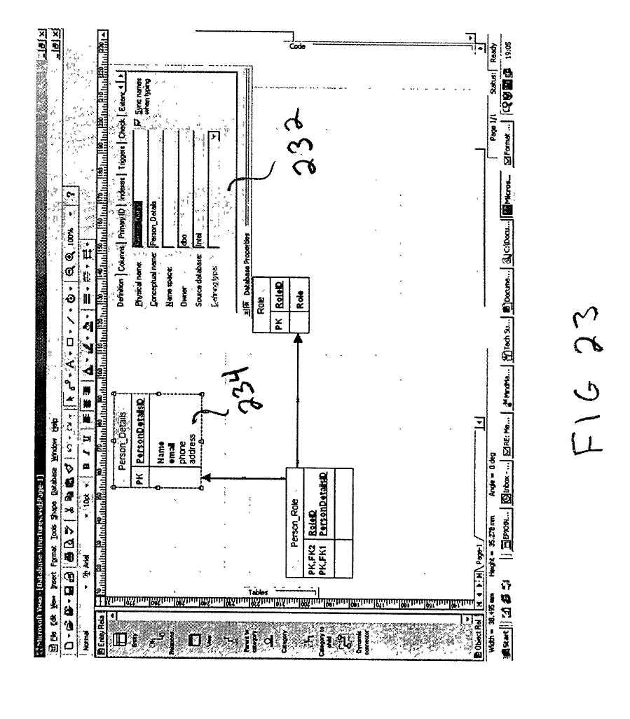

FIG. 22 illustrates how high level metadata can be accessed and edited during the Metadata Definition Step of an illustrative embodiment of the invention. For example, the application developer can view metadata associated with the Person_Details table 224 such as the table name, table owner, the table's source database file and its location on a disk using the database properties window 222 in FIG. 22. FIG. 23, the database properties window 232 of the example shows the field names for the Person_Details table 234 in list format and shows which field is the primary key (PrimaryID) and gives that primary key (which is a database structure) a specific name, ‘PK_Person_Details’ in this case.

Once the application metadata has been defined, a Create Application step 170 is performed. According to an illustrative embodiment of the invention, the Create Application step is performed automatically by rapid application development tools such as EpioBuilder™ available from Epionet Corporation. The EpioBuilder™ provides a function implementation system to automatically create business objects and collects newly created business objects for storage. The final web application is generated by operating on, combining and adding standard code segments to the data structures that have been most efficiently prepared according to the method of the present invention.

Rework

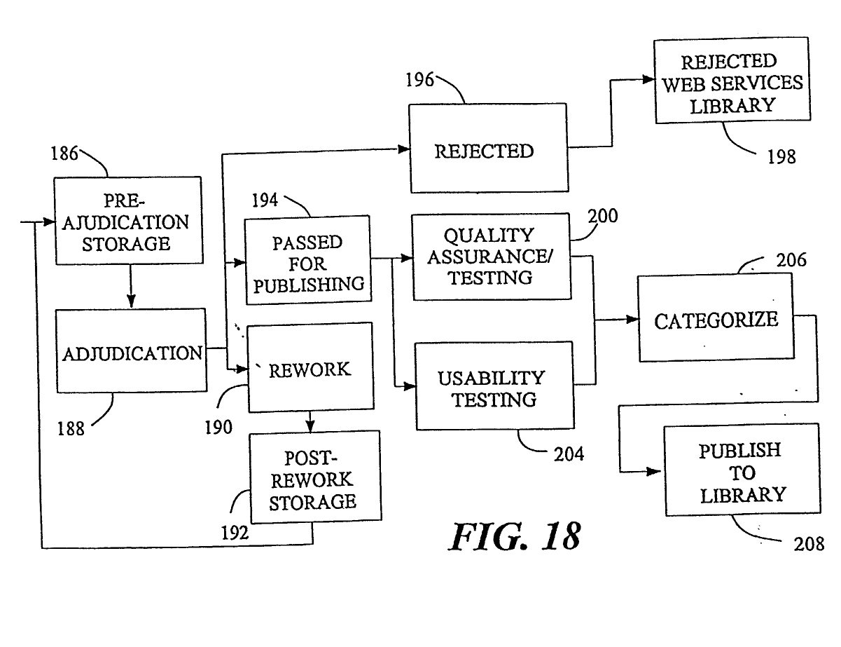

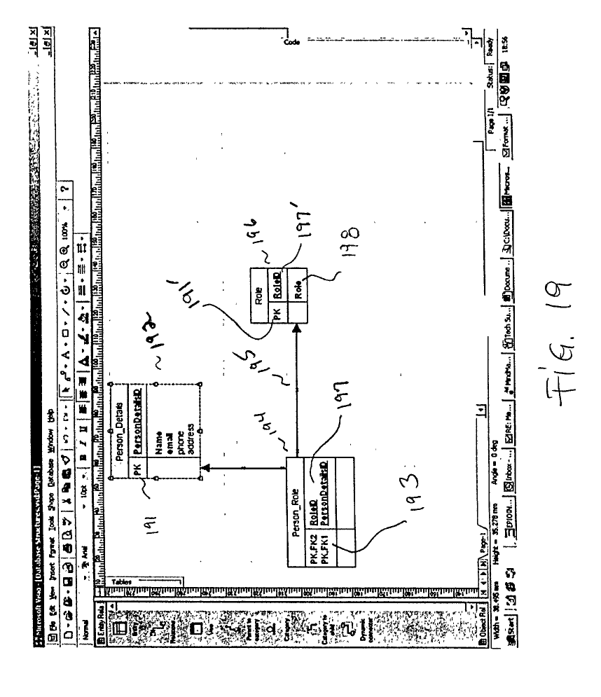

Once the application is completed, a Rework step 34, (see FIG. 1) can be performed to place the newly developed web services in form for addition to the Web Services Master Library. The Web Services Master Library must be maintained according to strict quality control standards to maximize the opportunity for software reuse such as the reuse of web services. The Rework step 34 is described in more detail with respect to FIG. 18.

According to the illustrative embodiment of the invention, an adjudication is performed to determine which of the assets, i.e., classes, components, prototypes, applications etc., are in some way suitable for reuse. The developer may make a preliminary determination that a particular component is suitable for reuse and place the component in pre-adjudication storage. An adjudicator, for example a reusability specialist, then passes judgment upon the reuse potential of the component in an adjudication step 186, based on criteria such as the needs of specific domains, specific vertical markets or specific horizontal markets.

If the adjudicator determines that the reuse potential of the component under consideration is not sufficient to justify rework, then the component is Rejected 196 and never published to the web services master library. Optionally, rejected components may be stored for later consideration in a Rejected web services library 198.

If the adjudicator determines that the component under consideration has some reuse potential but requires rework before it is suitable for publication to the master library, then a rework step 190 is performed to place the component in better form for reusability. The reworked component can then be stored 192 in post-rework storage and/or moved back to pre-adjudication storage 186 so that another adjudication cycle can be performed.

If the adjudicator determines that the component under consideration is suitable for publication, then the component is passed for publication 194. Before publication, both quality assurance testing 200 and usability testing 204 can be performed on the component to ensure that the master library contains only robustly reusable components. After testing, a categorization step 206 is performed to sort or index the components so that later discovery and retrieval will be optimized. The categorization step can include adding metatags to the components so that a search engine can be used for efficient retrieval. Once the components are categorized they can be published to the Master Library.

Development & Deployment Application Creation

Referring again to FIG. 1, according to the illustrative embodiment of the invention, a D&D Application Creation step 32 is performed. The steps within the D&D Application Creation step 32 are automated, according to the illustrative embodiment of the invention, using Epiowave™ development tools. The D&D Application creation step 32 is described in more detail with respect to FIG. 17.

During the D&D Application Creation step 32, a D&D application is created which allows the component based application under development to be run within a D&D system. In the illustrative embodiment of the invention, the D&D Application Creation step 32 corresponds to a step in which an application is created which runs within a development and deployment system. The development and deployment application provides a means through which all use of the functionality created by the application generator within the component based application may be regulated. It also provides a means for the developer to assign various presentation layers to the same application for use in different contexts. In the illustrative embodiment, Epiowave™ applications are created using the functionality of an application manager.

Once an application has been created, the programmer can create application pages, each of which is responsible for rendering certain aspects of the information of that application onto a particular interaction device such as a particular browser, PDA etc. Each page within the application contains specific code that carries out certain instructions as dictated by the programmer. It is within this code that the functionality of the component based application from the preceding step is accessed. The presentation framework of the application under development is created by constructing new templates 174 and integrating existing templates 176 in cases where reusability has been identified. Workspace creation 178 and workspace layout 180 are then performed.

In Epiowave™ based web systems, the physical presentation area of the browser or other interaction device is broken down into a number of areas, referred to as workspaces. Each of these workspaces is treated as a separate programmable area of the screen for an application developer. Each workspace is independent of all other workspaces. An application running in one workspace is also totally independent of other applications in other workspaces.

A layout manager within the development and deployment system provides a configuration toolset that allows the developer or administrator to turn off or turn on different workspaces on the screen, to manage the dimensions and appearance of each of the workspaces and to assign specific applications to appear in each workspace on the screen to achieve the desired layout for any context required. Accordingly, the system may be rapidly configured to have very specific visual interfaces for different users, groups etc.

Each of the applications running within a workspace must also be designed from an information display point of view. In an illustrative embodiment of the invention, in order to render the application information on the screen, the Epiowave™ application designer assigns specific XSL templates to each application. An XSL template is a file created using XSLT, a commonly used programming technology, that dictates how to render all the information for an application on the screen. The template dictates how that applications information will look on the screen including table layouts, button locations, font sizes etc., whereas by comparison, the workspaces dictate where an application's presentation layer is to be placed.

The application under development is then configured as a web service 182 and deployed 184. In an illustrative embodiment of the invention, the Epiowave™ provides a set of tools known collectively as a ‘Packager’, which allows for the rapid and easy deployment of web service applications. In order to deploy an application, that application must first be ‘Packaged’ using the Packager, and then unpackaged on the deployment or target server. A web service application is not just a single file on disk, but can consist of many different types of files and information sources, each playing a specific part in delivering the application functionality. An application can be made up of aggregations of many different file types, such as database files, image files, component files etc. as described hereinbefore. The packager creates a single distributable file out of all the individual resources required to make up an Epiowave™ application.

In the illustrative embodiment of the invention, the developer deploys an application by creating a new distributable file, called a ‘Package’, using the Packager configuration toolset. Once this file has been created, the package is sent to the administrator of the target deployment system (for example, as an email attachment), who then uses the Packager toolset on their server running the Epiowave™ development and deployment system as described hereinbefore. The application is automatically unpacked and deployed along with all its accompanying files. The application is then available via the application manager for the administrator to assign permissions to different users to use the application.

Although the present invention is described herein in terms of exemplary steps in a web service development system, persons skilled in the art should understand that any number of the illustrative steps may be deleted and further steps may be added to provide varying interfaces and optional functionality without departing from the spirit and scope of the present invention.

Although aspects of the present invention are described herein in terms of web services for business solutions, persons skilled in the art should appreciate that web service applications which do not necessarily relate to business solutions can be developed and deployed using the method of the present invention. For example web service applications for gaming, graphic arts, security, personal finance or communication can be developed within the scope of the present invention.

Although various illustrative embodiments of the present invention are described herein in terms of an Epiowave™ toolset by Epionet Corporation of Dublin, Ireland, persons skilled in the art should appreciate that various steps in the present invention may be performed without any particular toolset or with various other toolsets that are available from other sources without departing from the spirit and scope of the present invention. For example, application or system design can be performed using other methodologies such as a UML, or DSDM approach. UML is a standard approach to system architecture and design, and DSDM methodology is a Rapid Design and development methodology developed by the DSDM consortium. UML toolsets are available from several vendors such as Rational Software Corporation of Cupertino, Calif. and Lexington, Mass. These toolsets may in some instances, also provide application frameworks that deliver component based applications from the design templates. Another example of this type of product is NeuVis Architect by NeuVis Inc. of Shelton, Conn. which delivers automated component based application development from system models created using the product.

Although the invention is shown and described with respect to an illustrative embodiment thereof, it should be appreciated that the foregoing and various other changes, omissions, and additions in the form and detail thereof could be implemented without departing from the spirit and scope of the underlying invention Therefore, the above descriptions should not be construed as limiting, but merely as exemplification of the various embodiments.

What is claimed is:

1. A method for systematically creating web service based applications comprising the steps of:
assembling certified specifications;
refining said certified specifications to form a set of web services;
prioritizing said set of web services to form a prioritized web service set;
selecting web services for development from said prioritized web service set;
in the event that a visual interface is required for said selected web services, determining whether interface templates applicable to said web services for development are available in a template library;
compiling a list of interface templates to be used with said web services for development;
categorizing said interface templates on said list according to whether said interface templates are available for reuse, may be constructed by modifying an existing interface template, or must be constructed anew;
prioritizing said list of interface templates for development to form a prioritized template list; and
creating said interface templates according to said prioritized template list.

2. The method according to claim 1 further comprising the steps of:
upgrading said interface templates that are not optimally compatible with an overall application architecture; and
testing said interface templates for usability.

3. The method according to claim 1 further comprising the steps of performing an overall application architectural analysis to determine an overall architecture;
identifying web service based applications that are available for reuse and web service based applications that must be created anew;
designing classes and components within logical layers of said overall application architecture;
identifying existing classes and components that can be reused within said class and component designs; and
creating new classes and components for class and component designs that have not been identified as reusable from existing entities.

4. The method according to claim 3 further comprising the steps of:
defining web service metadata; and
creating said web service based applications according to said overall application architecture.

5. The method according to claim 4 further comprising the steps of:
in said event that a visual interface is required for said web service, constructing a presentation framework for said web service based application;
creating workspace pages to implement said template for interaction; and
creating a layout structure for the presentation of said workspace pages.

6. The method according to claim 3 wherein said architectural analysis step comprises the steps of:
designing a logical architecture of said web service according to the overall application architecture; and
designing a security architecture of said web service based application according to the overall application architecture.

7. The method according to claim 3 wherein said architectural analysis step comprises the steps of:
analyzing system environments within which said web service based application will be required to operate;
analyzing design goals of said web service based application; and
analyzing said web service based application to maximize reuse potential.

8. The method according to claim 1 wherein said certified specifications include business logic specifications.

9. A method for systematically creating web services comprising the steps of:
assembling certified business logic specifications;
refining said certified business logic specifications to form a list of web services;
prioritizing said list of web services to form a prioritized web service list;
selecting web services for development from said prioritized web service list;
determining whether interface templates applicable to said web services for development are available in a template library;
compiling a list of interface templates to be used with said web services for development;
categorizing said interface templates on said list according to whether said interface templates are available for reuse, may be constructed by modifying an existing interface template, or must be constructed anew;
prioritizing said list of interface templates for development to form a prioritized template list;
creating said interface templates according to said prioritized template list;
reviewing said interface templates for compatibility with an overall application architecture;
reworking or substituting interface templates that are not optimally compatible with said overall application architecture;
testing said interface templates for usability;
performing an overall architectural analysis;
identifying application entities that are available for reuse and application entities that must be created anew;
designing and creating databases for said web services;
designing classes and components within logical layers of said overall application architecture;
identifying existing classes and components that can be reused within said class and component designs;
creating new classes and components for class and component designs that have not been identified as reusable from existing entities;
defining web service metadata;
creating said web service using said classes and components according to said overall application architecture;
constructing a presentation framework for said web service;
creating workspace pages; and
laying out workspaces.

10. The method according to claim 9 wherein said steps of:
designing classes and components; creating new classes and components; constructing a presentation framework; creating workspace pages; and laying out workspaces are automated.

11. The method according to claim 9 further comprising the step of automatically adding said web service to a web service library.

12. The method according to claim 11 further comprising the steps of:
adjudicating said web services for reusability into sets of rejected, reworkable and reusable web services;
testing said reusable web services for quality assurance and usability;
categorizing said reusable web services;
publishing said reusable web services;
reworking said reworkable services by enhancing reusability of said reworkable web services;
re-adjudicating said reworked web services;
testing, categorizing, and publishing said reworked web services that have been deemed reusable during said re-adjudication step.

13. The method according to claim 9 wherein said architectural analysis step comprises the steps of:
designing a logical system architecture of said web service according to an overall application architecture; and
designing a security architecture of said web service according to an overall application architecture.

14. The method according to claim 9 wherein said architectural analysis step comprises the steps of:
analyzing system environments within which said web service will be required to operate;
analyzing design goals of said web service; and
analyzing said web service based application to maximize reuse potential.

15. The method according to claim 9 further comprising the step of:
deploying said web service.

16. The method according to claim 10 wherein said automation performed using means for rapid application development and deployment.

17. The method according to claim 16 further comprising the step of:
deploying said web service.

18. The method according to claim 17 wherein said deploying step comprising the steps of:
creating a single distributable package from a set of individual resources that make up an application;
delivering said package to a target computer system;
unpacking and installing said set of individual resources on said target computer system.

19. The method according to claim 18 wherein said steps of packing and unpacking comprise using a Packager software toolset.
